(19) United States
(12) Patent Application Publication
(10) Pub. No.: US 2026/0038151 A1
(43) Pub. Date: Feb. 5, 2026

(54) REGION TAGGING METHOD, INFORMATION PROCESSING METHOD, SYSTEM, APPARATUS, DEVICE AND MEDIUM

(71) Applicants: BEIJING BOE TECHNOLOGY DEVELOPMENT CO., LTD., Beijing (CN); BOE TECHNOLOGY GROUP CO., LTD., Beijing (CN)

(72) Inventors: Yue Li, Beijing (CN); Hao Fang, Beijing (CN)

(73) Assignees: BEIJING BOE TECHNOLOGY DEVELOPMENT CO., LTD., Beijing (CN); BOE TECHNOLOGY GROUP CO., LTD., Beijing (CN)

(21) Appl. No.: 18/995,955

(22) PCT Filed: Apr. 17, 2024
(86) PCT No.: PCT/CN2024/088440

§ 371 Date: Jan. 17, 2025

(30) Foreign Application Priority Data
May 31, 2023 (CN) 202310637609.9

(51) Int. Cl. G06T 7/80; G06T 7/70; G06V 10/25

(52) U.S. Cl. CPC G06T 7/80; G06T 7/70; G06V 10/25; G06T 2207/20104; G06T 2207/30244; G06V 2201/07

(57) ABSTRACT

A region calibration method includes: displaying a scene image collected by each of at least one first image collection apparatus located in a target scene, wherein the first image collection apparatus is used for performing image collection on part or all of regions in the target scene; displaying a candidate region selected by region drawing operation in a simulated image for simulating the target scene in response to the region drawing operation performed on the scene image; determining a calibrated region corresponding to each of a plurality of first image collection apparatuses based on the candidate region corresponding to each of the first image collection apparatuses; and respectively associating a plurality of calibrated regions with the plurality of first image collection apparatuses to indicate identification of objects to be identified in image regions framed by the calibrated regions in images collected by the first image collection apparatuses.

The disclosure claims the priority of the Chinese patent application filed on May 31, 2023 before the CNIPA, China National Intellectual Property Administration with the application number of 202310637609.9 and the title of “REGION CALIBRATION METHOD, INFORMATION PROCESSING METHOD AND SYSTEM, APPARATUS, DEVICE, AND MEDIUM”, which is incorporated herein in its entirety by reference.

### TECHNICAL FIELD

The disclosure relates to the technical field of information processing, and more particularly relates to a region calibration method, an information processing method and system, an apparatus, a device, and a medium.

### BACKGROUND

With the development of computer technology, an image collection apparatus is adopted for performing image collection on a target scene to perform businesses such as tracking of human traffic of a target region and motion of a target object according to results obtained by analyzing and processing the collected images. Illustratively, by taking a shopping mall scene as the target scene as an example, a plurality of cameras are arranged in a shopping mall, images collected by the cameras include shopping guides and guests entering the shopping mall for consumption, and guest traffic of the shopping mall may be analyzed by identifying the guests. In the related art, invalid information irrelevant to the businesses may exist in the images collected by the image collection apparatus, which causes interference in analysis and processing, thereby reducing the efficiency and accuracy of the analysis and processing.

### SUMMARY

In a first aspect of the disclosure, provided is a region calibration method, including:
displaying a scene image collected by each of at least one first image collection apparatus located in a target scene, wherein the first image collection apparatus is used for performing image collection on part or all of regions in the target scene;
displaying a candidate region selected by region drawing operation in a simulated image for simulating the target scene in response to the region drawing operation performed on the scene image;
determining a calibrated region corresponding to each of a plurality of first image collection apparatuses based on the candidate region corresponding to each of the first image collection apparatuses; wherein no overlap exists between at least two adjacent calibrated regions; and
respectively associating a plurality of calibrated regions with the plurality of first image collection apparatuses to indicate identification of image regions framed by the calibrated regions in images collected by the first image collection apparatuses.

The second aspect of the present disclosure discloses an information processing method, comprising:
respectively acquiring scene images collected by a plurality of image collection apparatuses on a target scene, and determining calibrated regions respectively corresponding to the plurality of image collection apparatuses; wherein the calibrated regions are determined by the region calibration method according to the first aspect;
identifying objects to be identified in target regions of the scene images to obtain target information; wherein the target regions are regions framed by the calibrated regions; and
executing information processing corresponding to a scene task on each piece of the target information, wherein the scene task is a task corresponding to the target scene.

The third aspect of the present disclosure discloses an information processing system, comprising: a first module, a second module, and a plurality of image collection apparatuses located in a target scene; wherein the first module and the second module are both connected to the plurality of image collection apparatuses;
wherein the first module is configured to execute the region calibration method according to the first aspect; and
the second module is configured to execute the information processing method according to the second aspect based on a calibrated region corresponding to each of the image collection apparatuses.

The fourth aspect of the present disclosure disclose a region calibration apparatus, comprising:
a display module configured to display a scene image collected by each of at least one first image collection apparatus located in a target scene, wherein the first image collection apparatus is used for performing image collection on part or all of regions in the target scene;
a drawing module configured to display a candidate region selected by region drawing operation in a simulated image for simulating the target scene in response to the region drawing operation performed on the scene image;
a determination module configured to determine a calibrated region corresponding to each of a plurality of first image collection apparatuses based on the candidate region corresponding to each of the first image collection apparatuses; wherein no overlap exists between at least two adjacent calibrated regions; and
an association module configured to respectively associate a plurality of calibrated regions with the plurality of first image collection apparatuses to indicate identification of objects to be identified in image regions framed by the calibrated regions in images collected by the first image collection apparatuses.

The fifth aspect of the present disclosure discloses an information processing apparatus, comprising:
an image acquisition module configured to respectively acquire scene images collected by a plurality of image collection apparatuses on a target scene, and calibrated regions respectively corresponding to the plurality of image collection apparatuses; wherein the calibrated regions are determined by the region calibration method above;
an identification module configured to identify objects to be identified in target regions of the scene images to obtain target information; wherein the target regions are regions framed by the calibrated regions; and
an information processing module configured to execute information processing corresponding to a scene task on each piece of the target information, wherein the scene task is a task corresponding to the target scene.

The present disclosure further discloses an electronic device, comprising: a memory, a processor, and a computer program stored on the memory and capable of running on the processor, wherein the processor implements the region calibration method according to the first aspect, or the information processing method according to the second aspect during execution.

The fourth aspect of the embodiment of the present disclosure discloses a computer-readable storage medium, wherein a computer program stored therein causes a processor to execute the region calibration method according to the first aspect, or the information processing method according to the second aspect.

By adopting the region calibration method in the first aspect of the disclosure, the region calibration method may be applied in the target scene. Specifically, the scene image collected by each of a plurality of first image collection apparatuses located in the target scene may be displayed, and the candidate region selected by region drawing operation may be displayed in the simulated image for simulating the target scene in response to the region drawing operation performed on the scene image; then, the calibrated region corresponding to each of the plurality of first image collection apparatuses is determined based on the candidate region corresponding to each of the first image collection apparatuses; wherein no overlap exists between at least two adjacent calibrated regions; and thereafter, a plurality of calibrated regions are respectively associated with the plurality of first image collection apparatuses to indicate identification of objects to be identified in image regions framed by the calibrated regions in images collected by the first image collection apparatuses.

Since the candidate region corresponding to the drawing operation may be determined based on the region drawing operation executed on the scene image collected by the first image collection apparatus, that is, the candidate region on the scene image is allowed to be selected, and then the candidate region is displayed in the simulated image of the target scene, the calibrated region corresponding to each of the first image collection apparatuses may be determined based on the candidate region displayed in the simulated image, and after the calibrated region is determined, the first image collection apparatus may be bound with the calibrated region. In this way, when the image collected by the first image collection apparatus is analyzed and processed, the calibrated region in the image may be analyzed and processed, while objects to be identified in regions which are not calibrated in the image may be prevented from being analyzed and processed. In this way, even if invalid information irrelevant to businesses exists in the image collected by the image collection apparatus, in analysis and processing, the invalid information may be excluded based on the calibrated region, while only valid information in the image is processed, so as to exclude the interference caused by the invalid information in the analysis and processing, thereby improving the accuracy of the analysis. Since the processing of the invalid information is reduced, a calculation amount is reduced, and the efficiency of the analysis and processing is improved simultaneously.

By adopting an image processing method in a second aspect of the disclosure, objects to be identified in target regions framed by calibrated regions in scene images collected by image collection apparatuses may be identified by utilizing the calibrated regions corresponding to the image collection apparatuses in a target scene, so as to obtain target information, and then information processing is performed on the obtained target information. Since each of the image collection apparatuses has the corresponding calibrated region, when identifying the objects to be identified in the images collected by the image collection apparatuses, identification of objects to be identified may be prevented from being performed on invalid regions outside the target regions, so as to improve the pertinence of image processing and avoid the processing of the invalid information, thereby reducing the calculation amount, and improving the accuracy of information processing.

The above description is merely an overview of the technical solution disclosed herein. In order to provide a clearer understanding of the technical means of the present disclosure, it can be implemented in accordance with the content of the specification. Furthermore, in order to make the aforementioned and other objectives, features, and advantages of the present disclosure more apparent and understandable, the following specific embodiments of the present disclosure are provided.

### BRIEF DESCRIPTION OF THE DRAWINGS

To more clearly illustrate the technical solutions in the embodiments of the present disclosure or in the related art, a brief introduction to the figures that will be used in the description of the embodiments or related art is provided below. It is evident that the figures described below are some embodiments of the present disclosure. For those skilled in the art, other figures can be derived from these figures without the need for creative labor. It should be noted that the proportions in the figures are for illustrative purposes only and do not represent actual proportions.

FIG. 1 shows a schematic diagram of an application scene in which a region calibration method and an information processing method of the disclosure are applied;

FIG. 2 shows a flowchart of steps of the region calibration method in an example of the disclosure;

FIG. 3 shows a schematic flow diagram of the region calibration method in an example of the disclosure applied in an implementation environment shown in FIG. 1;

FIG. 4 shows a schematic diagram of a change in an interface before and after region adjustment operation on a candidate region on a simulated image in an example of the disclosure:

FIG. 5a shows a schematic diagram of an interface for adaptive adjustment of the candidate region in an example of the disclosure;

FIG. 5b shows a schematic diagram of another interface for adaptive adjustment of the candidate region in an example of the disclosure;

FIG. 6 shows a schematic flow diagram of determining an installation pose by taking the application scene of FIG. 1 as an example in an example of the disclosure;

FIG. 7 shows a schematic flow diagram of steps of determining a coordinate conversion parameter in an example of the disclosure;

FIG. 8 shows a schematic flow diagram of steps of adjusting the calibrated region after a position of an image collection apparatus changes in an example of the disclosure;

FIG. 9 shows a schematic flow diagram of steps of the information processing method in Example 2 of the disclosure;

FIG. 10 shows a complete schematic flow diagram of a combination of the region calibration method and the information processing method of the disclosure by taking a furniture store shown in FIG. 1 as an example;

FIG. 11 shows a schematic structural diagram of a region calibration apparatus in an example of the disclosure;

FIG. 12 shows a schematic structural diagram of an information processing apparatus in an example of the disclosure; and

FIG. 13 shows a schematic structural diagram of an information processing system in an example of the disclosure.

### DETAILED DESCRIPTION OF THE EMBODIMENTS

In order to make the objectives, technical solutions, and advantages of the embodiments of the present disclosure clearer, the following will provide a clear and complete description of the technical solutions in the embodiments of the present disclosure, in conjunction with the figures in the embodiments. It is evident that the described embodiments are only a part of the embodiments of the present disclosure, not all of them. All other embodiments obtained by those skilled in the art without making creative labor based on the embodiments of the present disclosure are within the scope of protection of the present disclosure.

Some conventional solutions to the problems in the related art are as follows: firstly invalid information in images is identified, for example, the invalid information is identified through content correlation between the images collected by a plurality of image collection apparatuses, and then remaining valid information is processed after the invalid information is eliminated from the images; and a relatively large calculation amount is consumed due to the identification of the invalid information in this mode, and the accuracy of the identification is not necessarily reliable and does not necessarily match an analysis business to be targeted.

In view of this, the disclosure provides an improved idea for solving the above technical problem: in a target scene, an image collection range of an image collection apparatus may be determined through an image collected by the image collection apparatus, one calibrated region is determined within the image collection range, then the calibrated region is associated with the image collection apparatus, and thus a region which needs to be identified in the image collected by the image collection apparatus may be indicated by the calibrated region, so that invalid information in the image is eliminated from the source, further the identification, elimination, and the like of the invalid information may be avoided, and the pertinence of analysis and processing of valid information may also be improved while reducing the calculation amount and improving the efficiency, thereby improving the accuracy of the analysis and processing.

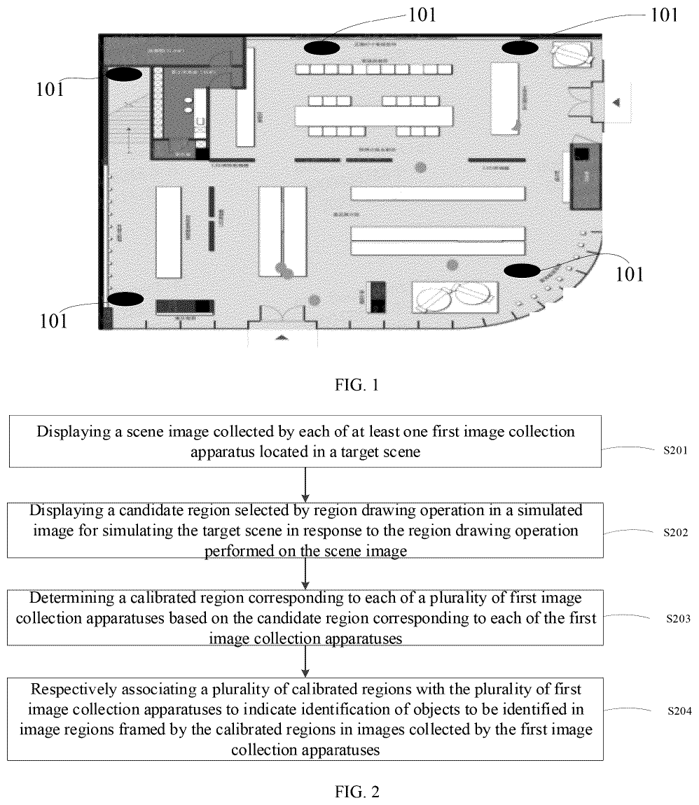

With reference to FIG. 1, a schematic diagram of an application scene in which a region calibration method and an information processing method of the disclosure are applied is shown. As shown in FIG. 1, by taking a shopping mall scene as a target scene as an example, a plurality of image collection apparatuses 101 are arranged in a shopping mall, wherein the plurality of image collection apparatuses 101 may be original devices of the shopping mall. For the shopping mall scene, businesses which need to be performed include a guest traffic statistics business, a guest flow tracking business, a shopping guide tracking business, and the like, and different businesses need to be performed based on images collected by the image collection apparatuses;
wherein description is made by taking a two-dimensional planar engineering drawing of a merchant as an example in FIG. 1.

In practice, this is not limited to the above scene, and for another example, by taking a factory scene as the target scene as an example, especially an unmanned factory, a plurality of image collection apparatuses are arranged in the factory, wherein the plurality of image collection apparatuses may be original devices of the factory. For the factory, businesses which need to be performed include monitoring of movement trajectories of robots in the factory, monitoring of trajectories of loaders and transporters, statistics on distribution quantities of the loaders and transporters in a plurality of production lines, and the like, so that loading and transporting equipment of the factory may be reasonably scheduled to adapt to production capacities of the production lines.

Of course, in addition to the above application scenes, other application scenes may also be included in practice, and the region calibration method provided in the disclosure may be applicable to a plurality of application scenes in which the image collection apparatus needs to be arranged for image collection and the collected image needs to be processed and analyzed.

In one example, the region calibration method of the disclosure is introduced and described in conjunction with FIG. 1.

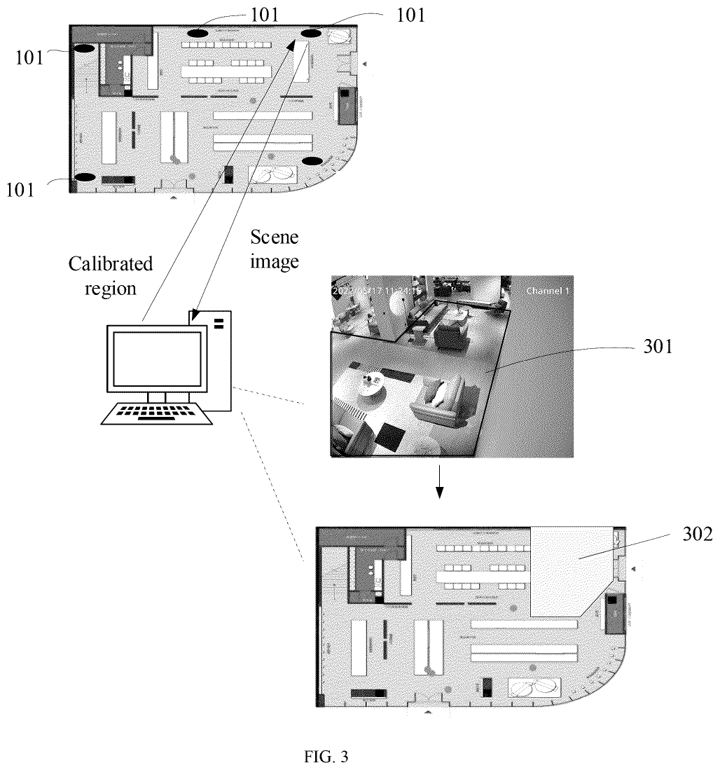

With reference to FIG. 2 and FIG. 3, FIG. 2 shows a flowchart of steps of the region calibration method in this example, and FIG. 3 shows a schematic flow diagram of the region calibration method in this example applied in an implementation environment shown in FIG. 1; and as shown in FIG. 2, this region calibration method may be applied in a first electronic device, and the first electronic device may be located in a target scene or not located in the target scene. The region calibration method may specifically include the steps of:
step S201: displaying a scene image collected by each of at least one first image collection apparatus located in a target scene:
wherein the first image collection apparatus is used for performing image collection on part or all of regions in the target scene.

In this example, the target scene may be an actual scene constructed in a physical region, which may be understood as a physical scene set up by a building region and items located in the building region together, such as a furniture store which is a furniture selling scene formed by arranging various types of furniture in a house, wherein the target scene includes the building region and the items located in the building region;
wherein the first image collection apparatus may be an inherent device originally disposed in the building region, and may be understood as a device arranged for other tasks when the target scene is initially set up, for example, the first image collection apparatus may be installed in the store when the furniture store is decorated, and thus the reuse of an existing image collection device in the target scene may be achieved;
wherein the first image collection apparatus may be a photographing device such as a camera or a ball machine, but is not limited to the above devices. It should be noted that when the first image collection apparatus is the ball machine, since the ball machine may achieve the rotation of the camera to adjust an image collection range, in the example of the disclosure, the ball machine may be fixed at a certain rotating position to calibrate a calibrated region of the ball machine at the fixed position;
wherein one first image collection apparatus may be disposed in the target scene, and a plurality of first image collection apparatuses may also be disposed in the target scene. In the case where one first image collection apparatus is disposed, the first image collection apparatus may perform image collection on part or all of regions in the target scene, and preferably may perform image collection on all of the regions; and in the case where the plurality of first image collection apparatuses are disposed, different first image collection apparatuses may perform image collection on different regions in the target scene, and intersection may be allowed between image collection ranges of the different first image collection apparatuses. Specifically, the image collection ranges of the first image collection apparatuses may be determined according to a size of the target scene; and
wherein the first image collection apparatus performing image collection on all of the regions in the target scene means that the scene image collected by the first image collection apparatus includes all of the regions of the target scene, that is, all of the regions are located within the collection range of the first image collection apparatus; and by the same reasoning, the first image collection apparatus performing image collection on part of the regions in the target scene means that part of the regions of the target scene are located within the collection range of the first image collection apparatus.
Step S202: displaying a candidate region selected by region drawing operation in a simulated image for simulating the target scene in response to the region drawing operation performed on the scene image.

In this example, the scene image collected by the first image collection apparatus may be sent to the first electronic device and displayed in a system installed on the first electronic device, the system may be used for performing region calibration, specifically, the scene image may be displayed in a first image drawing interface of the system, and the first image drawing interface may be an interface used for drawing regions of the scene image;
wherein tools for performing region drawing are provided in the first image drawing interface, such as a graphic frame and a line, a user may draw a region to be selected (hereinafter referred to as a drawing region) on the scene image by clicking drawing tools or using shortcut keys to use the drawing tools, and the region to be selected is a region containing no invalid information or less invalid information; and
wherein the region drawing operation may be performed by the user on the first image drawing interface for the scene image, in practice, a layer may be added on the scene image, the region drawing operation may be performed on the layer, and after the drawing is completed, the drawing region drawn on the layer may be associated with the scene image and stored.

It should be noted that the drawing region drawn by the region drawing operation may be determined according to objects needing to be identified in the target scene (objects to be identified). Under the condition that the object needing to be identified is a human body, the selected region may be a region where the human body is generally located. By taking a furniture store as an example, under the condition that the object to be identified is the human body, the selected region generally does not include regions such as a wall and a cabinet in the target scene.

Thus, by providing the image drawing interface to the user, the region containing no invalid information or less invalid information may be calibrated for the image collected by the image collection apparatus through manual operation, thereby improving the accuracy of region calibration and providing visual operation for the user. Compared with a solution in which a calculation algorithm is adopted in a later stage, different algorithms need to be set for different cases, a development amount is relatively large, and excessive calculation resources are consumed, by adopting the region drawing operation based on the user, a region calibration solution which consumes few hardware and software resources and is more time-saving and labor-saving may be provided.

In this example, since the drawing region is drawn based on the region drawing operation of the user, a shape thereof may be any shape adapted to a coverage region, thereby improving a matching degree between the calibrated region and a region where valid information in the target scene is located;
wherein the drawn drawing region may be mapped into the simulated image for simulating the target scene for display in response to the drawing region drawn by the region drawing operation, so as to obtain the candidate region located in the simulated image, wherein the simulated image may be an equally scaled engineering planar drawing of the target scene, and of course, in some instances, the simulated image may also be an equally scaled three-dimensional stereogram of the target scene, without specific limitation herein. It should be noted that the simulated image may include a simulated portion of a building region in the target scene and a simulated portion of an item arranged in the building region; and
wherein when the simulated image is a three-dimensional stereoscopic image, it is necessary to map the drawing region drawn by the region drawing operation into a three-dimensional space, so that the selected region is rendered more stereoscopically.

As shown in FIG. 3, by taking the scene shown in FIG. 1 as an example, the scene image collected by the first image collection apparatus 101 at an upper right corner in the target scene is sent to the first electronic device, the first electronic device displays the scene image on the first drawing interface, the user performs the region drawing operation on the first drawing interface by utilizing drawing work to obtain the drawing region 301, and then the drawing region 301 is mapped onto the simulated image of the target scene to obtain the candidate region 302 on the simulated image.

It should be noted that one drawing region may be allowed to be drawn in the scene image collected by one first image collection apparatus, and a plurality of drawing regions may also be allowed to be drawn, for example, two or even three drawing regions are drawn in one scene image, and different drawing regions may contain different image regions in the scene image.
Step S203: determining a calibrated region corresponding to each of a plurality of first image collection apparatuses based on the candidate region corresponding to each of the first image collection apparatuses;
wherein no overlap exists between at least two adjacent calibrated regions.

In this example, whether each of the candidate regions covers a valid region which needs information analysis and processing in the target scene may be determined according to the candidate region corresponding to each of a plurality of first image collection apparatuses displayed in the simulated image, wherein the valid region may refer to a region where an identification result of the object to be identified is valid. Illustratively, by taking the furniture store scene as the target scene as an example, in this scene, the valid region may be determined according to the object to be identified, under the condition that the object to be identified is a position where a customer entering the store is located, the determined valid region may refer to furniture exhibition regions other than walls, furniture, and stocking regions. In this case, the identification of the position of the customer in the exhibition regions is valid, and identification results in the regions such as the walls and furniture is invalid, thereby preventing the walls and furniture (such as desktops and cabinets) from being identified as the position where the customer is located when identifying the position of the customer;
wherein in the case where a plurality of candidate regions completely cover the valid region in the target scene, each of the candidate regions may be taken as the calibrated region corresponding to the corresponding first image collection apparatus;
wherein in order to avoid repeated analysis of the valid information due to the presence of the valid information in the candidate regions corresponding to different first image collection apparatuses, an overlapping region between the candidate regions may be displayed in the simulated image, and then the overlapping region is processed, so that no overlapping region exists between each of the candidate regions, or at least no overlapping region exists between the candidate regions which do not need repeated analysis, and thus no overlapping region exists between at least two adjacent calibrated regions;
wherein processing the overlapping region may include: removing the overlapping region in one of the candidate regions while preserving the integrity of the other candidate region; or the overlapping region is divided into the two overlapping candidate regions in proportion according to an overlapping shape of the overlapping region, so that the two candidate regions each take part of the overlapping region. Illustratively, by taking the overlapping region of the candidate region 1 and the candidate region 2 as a triangle as an example, firstly a perpendicular line of the triangle may be determined, then a triangular region is divided into two triangular regions according to the perpendicular line, one of the two triangular regions is allocated to the candidate region 1, and the other triangular region is allocated to the candidate region 2, so that the two candidate regions do not overlap with each other.

The overlapping region is processed in such a way that the processed calibrated region is still located in the original candidate region, but no overlapping region exists between the calibrated regions anymore, so that repeated valid information is no longer available, and thus the repeated analysis of the valid information may be avoided.
Step S204: respectively associating a plurality of calibrated regions with the plurality of first image collection apparatuses to indicate identification of objects to be identified in image regions framed by the calibrated regions in images collected by the first image collection apparatuses.

After the calibrated region corresponding to each of the first image collection apparatuses is determined, the calibrated region may be associated with the first image collection apparatus, wherein a coordinate position of the calibrated region in the scene image collected by the first image collection apparatus may be associated with the first image collection apparatus, that is, a coordinate of the calibrated region in an image coordinate system may be associated with the first image collection apparatus, and the image coordinate system herein may refer to a coordinate system of the first image collection apparatus;

wherein after associating the calibrated region with the first image collection apparatus, only the object to be identified in the image region corresponding to the calibrated region in the image collected by the first image collection apparatus may be identified.

As shown in FIG. 3, when the first image collection apparatus at the upper right corner collects the scene image during use, only the object to be identified in the image region framed by the calibrated region 302 in the image is identified, while other regions in the image are not identified. Assuming that the calibrated region 302 is the region corresponding to the drawing region 301 (namely, the candidate region corresponding to the drawing region 301 is not adjusted in the simulated image, but is directly determined to be the calibrated region corresponding to the first image collection apparatus at the upper right corner), when identifying the object to be identified in the image collected by the first image collection apparatus at the upper right corner, the object to be identified located in the drawing region 301 in the image is identified.

It can be seen from FIG. 3 that a shape of the calibrated region is not fixed, a region in an arbitrary shape may be formed through drawing work, and thus a region rich in only valid information may be accurately screened out. Then, the first electronic device may return an image coordinate of the calibrated region in the scene image to the first image collection apparatus at the upper right corner.

By adopting the region calibration method provided in this example, manual selection of the drawing region on the scene image may be achieved by executing the region drawing operation on the scene image, and then the drawn drawing region of each of the first image collection apparatuses is mapped into the simulated image of the target scene to obtain the candidate region corresponding to each of the first image collection apparatuses, the calibrated region corresponding to each of the first image collection apparatuses may be determined based on an exhibition situation of each of the candidate regions on the simulated image, and after the calibrated region is determined, the calibrated region may be bound with the first image collection apparatus. In this way, when the image collected by the first image collection apparatus is analyzed and processed, the objects to be identified in the image regions framed by the calibrated regions in the image may be analyzed and processed, while the objects to be identified in the image regions which are not calibrated in the image may be prevented from being analyzed and processed. In this way, even if invalid information irrelevant to businesses exists in the image collected by the image collection apparatus, in analysis and processing, the invalid information may be excluded based on the calibrated region, while only valid information in the image is processed, so as to exclude the interference caused by the invalid information in the analysis and processing, thereby improving the accuracy of the analysis. Since the processing of the invalid information is reduced, a calculation amount is reduced, and the efficiency of the analysis and processing is improved simultaneously.

In some examples, when the candidate regions are displayed on the simulated image, the candidate regions and the overlapping region between each of the candidate regions may be displayed. Specifically, the overlapping region between each of the candidate regions may be determined on the simulated image, and each of the candidate regions and the overlapping region of each of the candidate regions may be displayed.

In this example, the simulated image, the candidate region and the overlapping region may be displayed in a second image drawing interface, wherein a display window is provided in the second image drawing interface, the simulated image, the candidate region and the overlapping region are displayed in the display window, and the simulated image, the candidate region and the overlapping region are all based on the same coordinate system, namely, the coordinate system of the simulated image.

During display, two layers may be provided, wherein one layer is used for displaying the simulated image, and the other layer is used for displaying the candidate regions and the overlapping region between the candidate regions; and in some other examples, three layers may also be provided, wherein one layer is used for displaying the simulated image, another layer is used for displaying the candidate regions, and yet another layer is used for displaying the overlapping region between the candidate regions. Of course, in order to facilitate the adjustment of the candidate regions in the second image drawing interface, the overlapping region and the candidate regions may be displayed in the same layer;
wherein since the overlapping region is an overlapping part of the candidate regions, the overlapping region in the candidate region and a part which does not overlap with other candidate regions may be displayed with different transparency, for example, the transparency of the overlapping region is lower, so that the user may distinguish the overlapping part and the non-overlapping part in the candidate region.

In some other examples, in addition to displaying the overlapping region, an uncovered region which is not covered by the candidate region may also be displayed, and the uncovered region may include: a region which is not located within the collection range of the first image collection apparatus, and a region which is located within the collection range of the first image collection apparatus but is not covered by the candidate region.

In this example, in one case, since the first image collection apparatus in the target scene may perform image collection on part of regions in the target scene, the scene images collected by a plurality of first image collection apparatuses do not necessarily completely cover the target scene, so that the candidate regions also do not cover all of the simulated image; and in another case, even if the first image collection apparatuses completely cover the target scene, since the candidate regions are part of the regions in the scene image, each of the candidate regions may not cover all of the target scene, and therefore, the uncovered region which is not covered by the candidate regions exists. Thus, the uncovered region may include only a region which is not located within the collection range of the first image collection apparatus, or only a region which is located within the collection range of the first image collection apparatus but is not covered by the candidate region; or in the case where a plurality of uncovered regions exist, the uncovered regions include both the region which is not located within the collection range of the first image collection apparatus and the region which is located within the collection range of the first image collection apparatus but is not covered by the candidate region.

Since the overlapping region and the uncovered region may be displayed in the simulated image, a plurality of candidate regions where the overlapping region exists may be adjusted, and for the uncovered region, full coverage of the target scene may be achieved by adding a second image collection apparatus 102 in the target scene to cover the uncovered region.

In some examples, the determination of the calibrated region may be determined according to the adjustment of the candidate region by the user on the second image drawing interface, that is, the user may be allowed to adjust the candidate region, so as to determine the calibrated region corresponding to each of the image collection apparatuses based on the region adjustment operation of the user on the candidate region. In this case, it is convenient for on-site construction personnel to accurately divide the calibrated region and provide a convenient way for the on-site construction personnel to operate manually.

In some other examples, the determination of the calibrated region may be performed by the electronic device, and specifically, each of the candidate regions having an overlap may be adaptively adjusted according to the overlapping region between each of the candidate regions, so as to obtain the calibrated region corresponding to each of the first image collection apparatuses. In this mode, the calibrated region may be adaptively obtained by the electronic device according to a pre-stored software program without manual intervention, so that the workload of a worker may be reduced;
wherein in the case where the user is allowed to adjust the candidate region, the calibrated region corresponding to each of the plurality of first image collection apparatuses may be determined in response to region adjustment operation on part or all of candidate regions in a plurality of candidate regions; and
in the case where the candidate regions are adaptively adjusted by the electronic device, each of the candidate regions may be adaptively adjusted based on the overlapping region between each of the candidate regions in the simulated image to obtain the calibrated region corresponding to each of the plurality of first image collection apparatuses.

Firstly, adjustment operation of the user on the candidate regions is described:
in one specific instance of this example, the simulated image and the candidate regions on the simulated image may be displayed in the second image drawing interface, graphic drawing tools are provided at the second image drawing interface, and the graphic drawing tools provide a tool for adjusting the candidate regions in the simulated image.

As described above, the simulated image and the candidate region may be located in different layers to modify the simulated image and the candidate region respectively, wherein the simulated image may be set in a state in which modification is not allowed, namely, the layer in which the simulated image is located is locked to prohibit the modification of the simulated image, and wherein the provided tool for adjustment may be used for adjusting a shape and a size of the candidate region on the layer of the candidate region. The user may adjust the shape and the size of the candidate region by selecting the corresponding tool. Specifically, the above region adjustment operation may include: adjustment operation on the shape and the size of the candidate region on the layer where the candidate region is located based on the selected tool.

After the region adjustment operation is completed, the user may trigger saving operation, and the first electronic device may display the adjusted candidate region on the simulated image in response to the saving operation while the adjusted candidate region may be saved.

Of course, in some instances, the adjustment of the candidate region may be performed multiple times, wherein the regions obtained after the multiple adjustment may all be saved, so that the user may select one of the adjusted regions as the calibrated region. Or, after the current adjusted region is obtained, the current adjusted region may cover the previous adjusted region before the current time, so that the saved adjusted regions are all the latest adjusted regions.

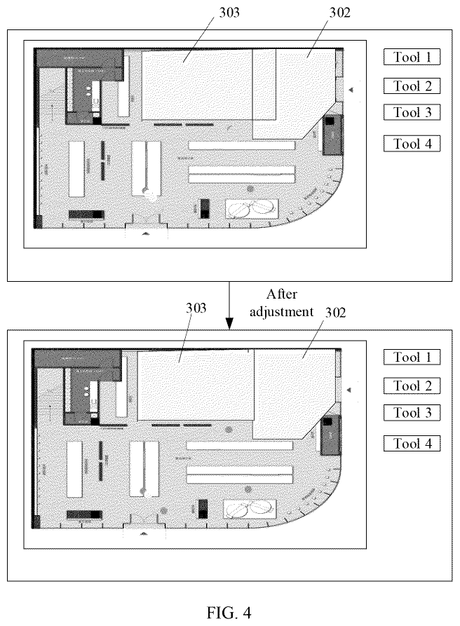

Illustratively, reference may be made to FIG. 4, and FIG. 4 shows a schematic diagram of a change in an interface before and after region adjustment operation on a candidate region on a simulated image. As shown in FIG. 4, there are a plurality of tools in the image drawing interface, at least including a shape adjustment tool and a size adjustment tool. The user may adjust the shape and the size of the candidate region by clicking the tools on the interface or by triggering shortcut keys on a keyboard to use these tools.

FIG. 4 is a schematic diagram of a change in the candidate region 302 and the candidate region 303 before and after adjustment. It can be seen that an overlapping region exists between the candidate region 301 and the candidate region 302 before adjustment, and no overlap exists between the two candidate regions after adjustment. Thus, it is ensured that repeated information is not included between the calibrated regions as much as possible;
wherein after performing region adjustment operation on one candidate region, the adjusted candidate region and other candidate regions may be displayed on the second image drawing interface, so that the user may observe whether the overlap exists between the adjusted candidate regions, and if so, the candidate region may be adjusted again.

In an optional mode, after the shape of the candidate region is adjusted, the size of the corresponding candidate region is also changed simultaneously, and since the candidate region is generally a region with valid information selected in the scene image, under the condition that the shape is unchanged and the size is simply adjusted, it is possible to miss some of the valid information after the adjustment. Therefore, in this optional mode, a scaling function for performing an overall change on the size of the candidate region may be locked, that is, a tool for scaling the region may be locked, so that the candidate region is not decreased as a whole, but no overlapping region exists between the candidate regions by changing the shape.

Next, adaptive adjustment of each of the candidate regions by the first electronic device is described:
wherein when adaptive adjustment is performed on each of the candidate regions, the adaptive adjustment may be performed based on the overlapping region between the candidate regions. In one type of adaptive adjustment, in the case where two candidate regions have the overlapping region, the overlapped overlapping region may be subtracted from any one of the two candidate regions with the overlap, and the remaining region of the candidate region is taken as the calibrated region; and
wherein the mode of subtracting the overlapping region from any one of the two candidate regions may be as follows: a first position coordinate of the overlapping region in the candidate region to be adjusted and a second position coordinate of the candidate region to be adjusted are determined, and the first position coordinate and the second position coordinate are calculated, so as to remove the overlapping region from the candidate region to be adjusted. Or after determining a position of the overlapping region in the candidate region to be adjusted, the overlapping region may be matted out of the candidate region to be adjusted by using a matting technique.

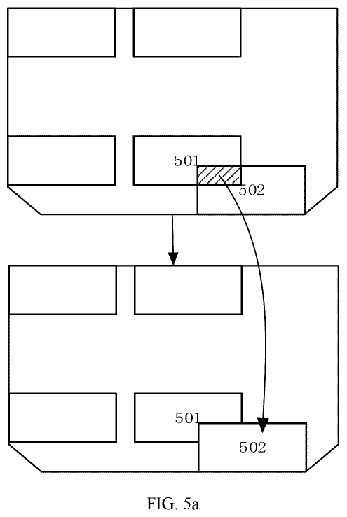

Illustratively, with reference to FIG. 5a, FIG. 5a shows a schematic diagram of an interface for adaptive adjustment of the candidate region. As shown in FIG. 5a, an overlapping region exists between the candidate region 501 and the candidate region 502, a shaded part in FIG. 5a is the overlapping region, the overlapping region may be subtracted from the candidate region 501, and the remaining region in the candidate region 501 is taken as the calibrated region of the first image collection apparatus A, while the complete region of the candidate region 502 is preserved.

Of course, in some other instances, the overlapping region may also be subtracted from the candidate region 502, and the remaining region in the candidate region 502 is taken as the calibrated region of the first image collection apparatus B, while the complete region of the candidate region S01 is preserved.

In another type of adaptive adjustment, in the case where the overlapping regions exist between a plurality of candidate regions, the plurality of candidate regions may be divided according to a quantity of other candidate regions having the overlapping regions with the candidate regions, and the candidate regions are divided into a first type of candidate regions, a second type of candidate regions and a third type of candidate regions, wherein the first type of candidate regions means that the candidate regions of this type have an overlap with only one other candidate region: the second type of candidate regions means that the candidate regions of this type have overlaps with other two candidate regions; and the third type of candidate regions means that the candidate regions of this type have overlaps with three or more other candidate regions; and
wherein when performing adaptive adjustment, each type of candidate regions may be adjusted iteratively according to an adjustment model respectively corresponding to each type of candidate regions, and the iteration herein may mean that firstly, the first type of candidate regions is adjusted, then the second type of candidate regions is adjusted on the basis of adjustment, and then the third type of candidate regions is adjusted on the basis of the adjusted second type of candidate regions, so that all of the candidate regions with the overlapping regions are finally adjusted to obtain the calibrated region.

Illustratively, as shown in FIG. 5b, one of the adjustment modes is given, wherein overlaps exist between the candidate regions 501-505, wherein the candidate region 505 and the candidate region 504 have an overlapping region b1, the candidate region 504 and the candidate region 501 have an overlapping region b2, the candidate region 501 and the candidate region 503 have an overlapping region b3, and the candidate region 501 and the candidate region 502 have an overlapping region b4, and wherein the first type of candidate regions is the candidate regions 505, 502 and 503, the second type of candidate regions is the candidate region 504, and the third type of candidate regions is the candidate region 501.

Firstly, the first type of candidate regions, namely, the candidate regions 505, 502 and 503, is adjusted, and specifically, the overlapping region b1 may be allocated to the candidate region 505, the overlapping region b3 is allocated from the candidate region 503, and the overlapping region b4 is allocated to the candidate region 502, so that the overlapping region b2 remains. As shown in FIG. 5b, the overlapping region b2 may be allocated to the candidate region 504, and since the overlapping region b3 is allocated from the candidate region 503, the overlapping region b3 may be allocated to the candidate region 501 when the candidate region 501 is adjusted, so as to obtain the adjusted candidate region.

Of course, in practice, additional adaptive adjustment modes may also be adopted, such as adjustment according to a positional sequence of the candidate regions on the simulated image, adjustment in a left-to-right sequence, or adjustment in a right-to-left sequence, which is not limited herein;
wherein the adjustment of the candidate regions may not only be limited to the adjustment of the candidate regions when the overlapping region exists between the candidate regions, but also may include the adjustment of the shape of the candidate region, for example, in some cases, the shape of the candidate region may be changed according to actual requirements, for example, for a plurality of candidate regions from the same scene image (a plurality of drawing regions are drawn in one scene image), the user may change the shapes of the plurality of candidate regions, for example, the plurality of candidate regions are stitched into one region, thereby resulting in a change in the shapes and the sizes of the candidate regions.

In some examples, adaptability of the adjusted candidate region to the scene image collected by the first image collection apparatus may be ensured, and the adaptability may mean that the adjusted candidate region is ensured to be located within the collection range of the first image collection apparatus without departing from the original candidate region. Specifically, the adjusted candidate region may be returned into the scene image for display, and specifically, the adjusted candidate region may be mapped back into the scene image for display, so that the user may check whether the adjusted candidate region meets the above adaptability.

During specific implementation, the adjusted candidate region may be mapped into the scene image from which the adjusted candidate region originates for display;
wherein the adjusted candidate region refers to a candidate region which is subjected to the region adjustment operation on the simulated image or subjected to adaptive adjustment by the first electronic device, and as shown in FIG. 3, assuming that the candidate region 301 is adjusted in the simulated image, the adjusted region needs to be mapped into the scene image shown in FIG. 3 for display, so that the adjusted region may be compared with the original drawing region 301 in the scene image.

In some specific instances of this example, the drawing region corresponding to the region drawing operation is displayed in the scene image from which the adjusted candidate region originates; and specifically, since the scene image may be displayed on the first image drawing interface, and the simulated image may be displayed on the second image drawing interface, wherein the adjustment of the candidate region occurs on the second image drawing interface, in practice, the adjusted candidate region may be returned to the first image drawing interface, and the adjusted candidate region is mapped on the scene image by the first image drawing interface;
wherein in order to distinguish the drawing region from the adjusted candidate region (hereinafter referred to as the adjusted drawing region) mapped on the scene image for display, the drawing region and the adjusted drawing region may be respectively displayed in different layers, and the two are displayed with certain transparency, so that the user may determine whether the adjusted drawing region is located within the drawing region;
wherein the drawing region is the candidate region when being mapped onto the simulated image. In this way, the drawing region and the adjusted drawing region (corresponding to the adjusted candidate region in the simulated image) may be compared on the scene image. Under the condition that the adjusted drawing region is located in the drawing region, it represents that the adjustment thereof does not depart from the original candidate region and is within the original collection range; and under the condition that an intersection region exists between the drawing region and the adjusted drawing region, the adjusted drawing region is not completely located in the drawing region, in the case of being not completely located in the drawing region, the adjusted drawing region contains some invalid information, thereby affecting the subsequent analysis and processing of the image. Therefore, the candidate region needs to be readjusted on the simulated image;
wherein the adjusted candidate region mapped into the scene image from which the adjusted candidate region originates for display may include: a region after region adjustment operation performed by the user, and a candidate region after adaptive adjustment performed by the first electronic device. That is, for either the adjustment of the candidate region by the user or the adaptive adjustment of the candidate region by the first electronic device, the adjusted candidate region may be returned into the scene image for display as the adjusted drawing region;
wherein under the condition that the adjusted drawing region is not completely located in the drawing region, the adjusted drawing region may contain some invalid information, and in this case, it is necessary to readjust the candidate region on the simulated image. Accordingly, when receiving modification operation on the adjusted candidate region in the scene image, a region corresponding to the modification operation may be displayed in the simulated image, and the steps of determining the calibrated region corresponding to each of a plurality of first image collection apparatuses based on the candidate region corresponding to each of the first image collection apparatuses is repeated.

That is, it is possible to continue to adjust the adjusted candidate region in the second image drawing interface, and after the adjustment each time, the adjusted candidate region may be returned to the first image drawing interface, so that the adjusted drawing region corresponding to the adjusted candidate region may be displayed in the scene image of the first image drawing interface, so as to check an adjustment effect.

Accordingly, in the case where the adjusted candidate region is mapped into the scene image from which the adjusted candidate region originates for display, the calibrated region may be determined by the following mode: when receiving determination operation for the adjusted candidate region, the adjusted candidate region is taken as the calibrated region of the corresponding first image collection apparatus;
wherein the determination operation may occur on the first image drawing interface, and may also occur on the second image drawing interface; when the determination operation occurs on the first image drawing interface, the current adjusted drawing region may be taken as the calibrated region of the first image collection apparatus; and since the scene image is displayed on the first image drawing interface, the coordinate of the adjusted drawing region thereof is the image coordinate, and the coordinate of the adjusted drawing region in the scene image may be directly bound with the first image collection apparatus;
wherein when the determination operation occurs on the second image drawing interface, the adjusted candidate region may be taken as the calibrated region, and the coordinate of the calibrated region on the simulated image is bound with the corresponding first image collection apparatus;
wherein it should be noted that when a plurality of candidate regions with overlapping regions are adjusted, the adjusted candidate regions become calibrated regions, and in some examples, the calibrated regions need to satisfy the condition of not overlapping with each other. In some other examples, the calibrated regions also need to be mutually stitched on the basis of not overlapping with each other to completely cover the simulated image.

Accordingly, as described above, in some scenes, a plurality of calibrated regions may not be required to completely cover the simulated image after being mutually stitched; however, in some scenes, the plurality of calibrated regions are required to completely cover the simulated image after being mutually stitched. In such a scene, for example, in a shopping mall scene, it is necessary to perform statistics on guest traffic of the shopping mall, and therefore it is necessary to identify guests in the shopping mall as much as possible without dead angles.

Accordingly, in order to enable the plurality of calibrated regions to completely cover the simulated image after being mutually stitched, an uncovered region may be displayed in the simulated image; and in practice, full-range image collection on the target scene may be achieved by adding a second image collection apparatus and performing image collection on the uncovered region by the second image collection apparatus; and
wherein the uncovered region may include a region not covered by the candidate region or a region not covered by the calibrated region.

Specifically, an installation pose of the second image collection apparatus in the target scene may be determined based on the uncovered region, and part or all of the uncovered region may be taken as the calibrated region of the image collection apparatus; wherein the second image collection apparatus is used for being newly added to the target scene to collect an image of the uncovered region.

In some scenes, even if the calibrated region of each of a plurality of first image collection apparatuses may completely cover the simulated image after being stitched, as time goes by, under the condition that the region of the target scene is expanded, for example, the store is expanded from the original 100 m² to 200 m², the original first image collection apparatus can only cover the range of 100 m², and the second image collection apparatus needs to be added for the newly increased region of 100 m² to cover the newly increased region of 100 m².

In some examples, after obtaining the candidate region on the simulated image based on the region drawing operation, the region which is not covered by the candidate region may be displayed on the simulated image, and in this case, the second image collection apparatus for the uncovered region may be firstly arranged in the target scene, and then the determination of the calibrated region corresponding to the second image collection apparatus is performed according to processes of the above steps S201 to S203. In such an example, it is possible for an on-site worker to divide the calibrated regions containing valid information in the case of ensuring that the target scene is completely covered by image collection ranges of the first image collection apparatus and the second image collection apparatus, so that the calibrated region of each of the image collection apparatuses may be determined at once. Such an example may be adapted to the case of area expansion of the above target scene.

In some other examples, after determining the calibrated regions corresponding to the plurality of first image collection apparatuses, the region which is not covered by the calibrated regions may be displayed on the simulated image, in this case, the second image collection apparatus may be directly arranged in the target scene, after determining that the collection range of the second image collection apparatus contains the range where the calibrated regions are located, the uncovered region may be directly taken as the calibrated region of the second image collection apparatus without determining the calibrated regions of the second image collection apparatus. In such an example, for the target scene, according to the image analysis requirements, after the calibrated region is determined, under the condition that the image collection apparatus needs to be added in the later stage, the region drawing operation on the scene image collected by the second image collection apparatus directly does not need to be performed by the worker, thereby simplifying the determination work of the calibrated region when the second image collection apparatus is newly added, so as to cope with the requirement that the calibrated region needs to be added due to the area expansion of the target scene, and the like. This example may be applicable to the case where the original first image collection apparatus of the target scene does not cover all of regions of the target scene but objects to be identified in the entire region of the target scene need to be identified;
wherein the second image collection apparatus needs to be newly added in the target scene to collect the scene image of the uncovered region, and in practice, the installation pose of the second image collection apparatus in the target scene needs to be determined, so that the image collection range of the second image collection apparatus at this installation pose may include the uncovered region.

However, the installation pose generally needs to be continuously debugged by the on-site worker according to pictures collected by the second image collection apparatus, wherein the installation pose includes an installation position and attitude of the second image collection apparatus, for example, for a ball machine, the installation pose not only includes the position, but also includes an rotating angle of the ball machine.

In a specific implementation of this example, a target image obtained by the second image collection apparatus performing image collection on the target scene at a candidate position may be acquired; a scene region included in the target image may be mapped into the simulated image to obtain a collection region; then position adjustment information is output based on the collection region and the uncovered region; and the installation pose is determined based on the position adjustment information.

In some examples, the candidate position may be the installation pose of the second image collection apparatus predicted by the electronic device based on a position of the region in which the uncovered region is located in the simulated image, and then whether the image collection range of the second image collection apparatus at the installation pose may cover the uncovered region may be manually determined on site. In this way, the workload of debugging the pose of the newly added image collection apparatus on site of the worker may be reduced; and
wherein the output position adjustment information may be a comparison result of the collection region and the uncovered region, and may also be display pictures of the collection region and the uncovered region on the simulated image; and wherein the output position adjustment information may be directly located in the electronic device, and may also be sent to the on-site worker, so that the on-site worker may check the position adjustment information and adjust the installation pose of the second image collection apparatus until it is determined that the collection region covers the uncovered region according to the position adjustment information.

In one instance of this specific implementation mode, the output position adjustment information may be information indicating how to adjust the candidate position according to the comparison result of the collection region and the uncovered region.

In the specific implementation, a type of coverage of the collection region covering the uncovered region may be determined; the position adjustment information is generated based on the type of coverage; and then the position adjustment information is sent to a user side.

In this case, the position adjustment information may include a movement direction or a movement distance of the candidate position of the second image collection apparatus, wherein the position adjustment information corresponds to the type of coverage, and in practice, preset adjustment information corresponding to each type of coverage may be sent to the user side as the position adjustment information, and the preset adjustment information may be pre-stored in the electronic device so as to be called; and
wherein the type of coverage may include three different types: the collection region completely covering the uncovered region, the collection region partially overlapping with the uncovered region, and the uncovered region completely covering the collection region; and each type corresponds to one piece of preset adjustment information.

Illustratively, under the type of the collection region completely covering the uncovered region, the position adjustment information is not needed, and then the position adjustment information of 0 may be output to represent that the current candidate pose is a correct pose; under the type of the collection region partially overlapping with the uncovered region, position adjustment needs to be performed, in this case, the corresponding preset adjustment information may be determined according to a position of an overlapping region where the collection region partially overlaps with the uncovered region on the simulated image, and different positions correspond to different preset adjustment information; in this case, the preset adjustment information may include a movement direction and a movement distance, so that a direction for debugging the installation pose of the second image collection apparatus may be indicated; and under the type of the uncovered region completely covering the collection region, a height of the second image collection apparatus needs to be adjusted to expand the image collection range thereof, and in practice, the preset adjustment information may indicate raising an installation height of the second image collection apparatus.

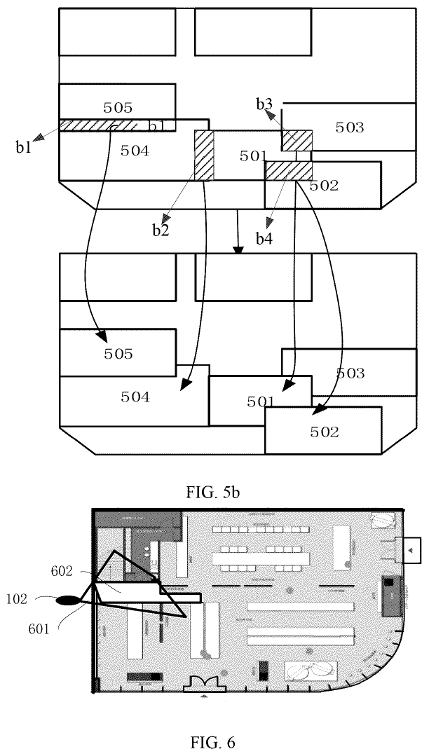

Illustratively, with reference to FIG. 6, a schematic flow diagram of this embodiment is shown by taking the application scene of FIG. 1 as an example. As shown in FIG. 6, the collection region 601 partially overlaps with the uncovered region 602, and the overlapping region faces a lower right direction of the simulated image compared with the uncovered region 601, so that the collection range of the second image collection apparatus 102 needs to be moved to an upper left direction in practice, and thus the actual installation pose of the second image collection apparatus in the target scene may be adjusted according to this.

By adopting the determining mode of the installation pose in this embodiment, firstly one candidate position may be directly predicted by the first electronic device according to the position of the uncovered region on the simulated image, then the on-site worker firstly places the second image collection apparatus at the candidate position, the region covered by the image shot by the second image collection apparatus is directly mapped back onto the simulated image, and the first electronic device may automatically compare the coverage situations (including complete coverage, partial coverage, and the like) of the region mapped back and the uncovered region, and then output a comparison result and a position adjustment strategy. The position adjustment strategy may be directly fed back to the on-site worker through communication, and after the on-site worker adjusts the installation pose according to the position adjustment strategy, the on-site worker continues to execute the above step until the first electronic device sends successful adjustment information such as “0” to the on-site worker when the collection range of the second image collection apparatus completely covers the uncovered region. In this case, the on-site worker may directly fix the second image collection apparatus on the installation pose determined at the last time, thereby avoiding the problem that the on-site worker needs to continuously determine the collection range at the first electronic device and the installation pose to and fro when installing the second image collection apparatus, so that one on-site worker may easily complete the installation of the newly added image collection apparatus, the labor cost is saved, and a more convenient and reliable installation way of the newly added device is also provided for the on-site worker.

In another instance of this specific implementation mode, the output position adjustment information may be display pictures of the collection region and the uncovered region on the simulated image, and during the specific implementation, picture interception may be performed on the simulated image displaying the collection region and the uncovered region; and the intercepted picture is sent to the user side as the position adjustment information. In this instance, the on-site worker may hold a portable display device, so that the intercepted picture may be sent to the on-site worker, so as to be convenient for the on-site worker to adjust the installation pose of the second image collection apparatus according to the intercepted picture, wherein the picture interception may be performed in real time, and specifically, the second image collection apparatus returns the collected scene image to the second image drawing interface in real time, the second image drawing interface maps all of AZ regions of the scene image onto the simulated image, and only the uncovered region may be displayed on the simulated image, while the first electronic device records the display pictures of the second image drawing interface, and feeds back the recorded pictures to the portable display device in real time, so that the on-site worker may observe the change situation of the scene image collected in an adjustment process of the installation pose in real time, so as to quickly determine the correct installation pose.

In this instance, the second image collection apparatus may be installed and debugged by the worker on site, and then according to the received picture, a coverage region of the image collected by the second image collection apparatus on the simulated image is determined, and whether the installation pose of the second image collection apparatus is correct is determined. Specifically, under the condition that the coverage region on the simulated image covers the uncovered region, it is represented that the image collection range of the second image collection apparatus covers the uncovered region, and the installation pose is correct; and under the condition that the coverage region on the simulated image does not cover the uncovered region, it is represented that the image collection range of the second image collection apparatus does not completely cover the uncovered region, and the installation pose needs to be adjusted.

By adopting the determining mode of the installation pose in this embodiment, firstly one candidate position may be directly selected by the on-site worker to install the second image collection apparatus, then image collection on the target scene performed by the second image collection apparatus at the candidate position is indicated, and then the complete image region of the target image collected by the second image collection apparatus is mapped onto the simulated image for display. In this case, the simulated image may only display the uncovered region and the region of the target image mapped back, so as to be convenient for comparing whether the uncovered region is located within the range covered by the target image; and since the picture displaying the simulated image, the region to be selected and the uncovered region may also be shared to a display device held by the on-site worker, the on-site worker may hold a simple display device at the position where the second image collection apparatus is installed, so that the determination of the position of the second image collection apparatus may be quickly completed, and thus the operation of the on-site worker may be simplified, and visual and operable hardware and software facilities are provided for the worker performing the on-site region calibration, thereby improving the efficiency of performing the region calibration of the worker;
wherein the process of how to map the drawing region drawn by the region drawing operation in the scene image collected by the image collection apparatuses (including the first image collection apparatus and the second image collection apparatus) onto the simulated image to become the candidate region in the disclosure is described.

In some examples, a drawing region selected by region drawing operation may be determined on the scene image in response to the region drawing operation; then the drawing region is mapped onto the simulated image according to a conversion relationship between an image coordinate system of the image collection apparatus and an image coordinate system of the simulated image to obtain a candidate region; and each of the candidate regions is displayed on the simulated image.

In a specific implementation mode, a first region coordinate of the drawing region selected by the region drawing operation may be determined on the scene image in response to the region drawing operation; a first region coordinate is converted into a second region coordinate on the simulated image; and then the image region is mapped onto the simulated image based on the second region coordinate to obtain the candidate region.

In this implementation mode, the first region coordinate is based on the image coordinate system of the scene image, that is, based on the coordinate system of the first image collection apparatus, the second region coordinate is based on the coordinate system of the simulated image, and generally, the simulated image is a scaled-down image of the target scene and is obtained based on a world coordinate system and an equal-scale relationship; and
wherein the first region coordinate includes coordinates of a plurality of endpoints of the drawing region, and in some cases, may also include a region center coordinate of the drawing region. Specifically, the first region coordinate may be determined according to a shape of the drawing region, wherein the second region coordinate corresponds to the first region coordinate, and under the condition that the first region coordinate includes the coordinates of the plurality of endpoints, the second region coordinate also includes the coordinates of the plurality of endpoints on the simulated image; and
wherein a mapping relationship between the first region coordinate and the second region coordinate may be a conversion relationship between the image coordinate system and the coordinate system of the simulated image.

As described above, the scene image is generally based on the image coordinate system of the image collection apparatus, while the simulated image is based on a coordinate system provided by engineering drawing software when drawing the target scene, and the conversion between the two may be mediated by the world coordinate system. Specifically, the world coordinate system may be understood to be a real world coordinate system, and in this example, a coordinate conversion relationship between the image coordinate system and the world coordinate system may be constructed, and a conversion relationship between the world coordinate system and the coordinate system of the simulated image may be constructed. By taking the world coordinate system as a coordinate system mediation, coordinate conversion is achieved between the image coordinate system of the image collection apparatus and the coordinate system of the simulated image, so that the image region in the scene image is mapped onto the simulated image according to this conversion relationship.

In practice, when constructing the coordinate conversion relationship between the image coordinate system and the world coordinate system, firstly coordinate calibration may be performed on the image collection apparatus located in the target scene. Specifically, the calibration may be performed by acquiring a position parameter of the image collection apparatus in the target scene, and this position parameter is mainly used for determining the coordinate conversion relationship between the image coordinate system of the image collection apparatus and the world coordinate system.

During specific implementation, the above position parameter may be acquired by disposing a plurality of marking icons in the target scene, and the plurality of marking icons may be used for determining eight position parameters.

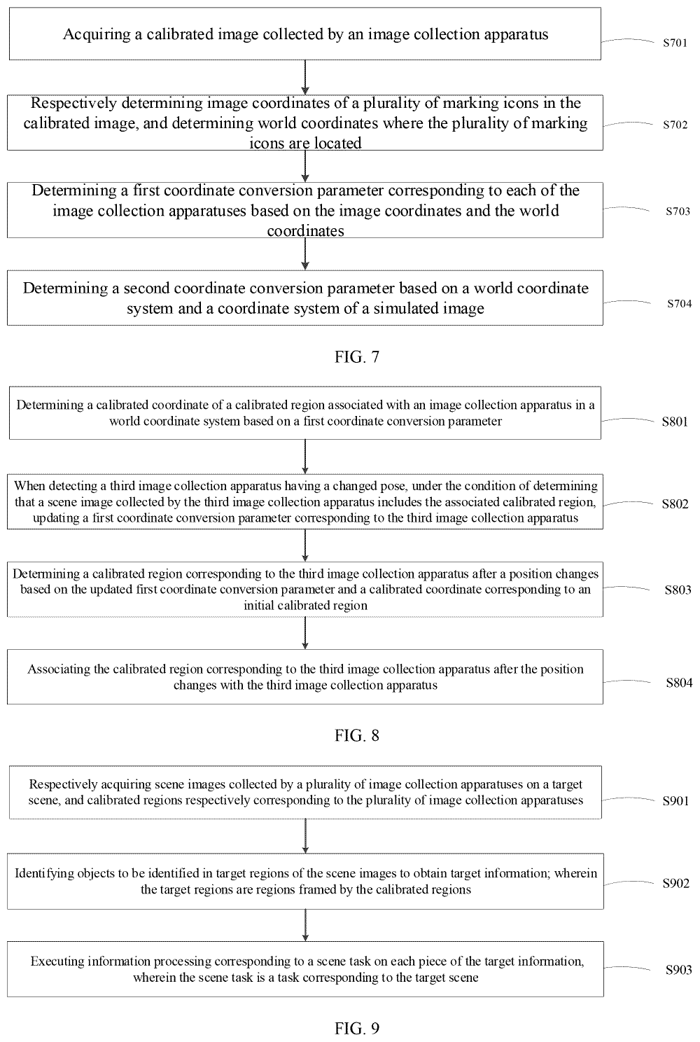

With reference to FIG. 7, a schematic flow diagram of steps of determining a coordinate conversion parameter in this example is shown. As shown in FIG. 7, the following steps may be specifically included:

step S701: acquiring a marked image collected by an image collection apparatus;
wherein the marked image includes images of a plurality of marking icons located in the target scene; and the image collection apparatus includes a first image collection apparatus and a second image collection apparatus.

In this example, the image collection apparatus is located in the target scene, may be the first image collection apparatus, and may also be the second image collection apparatus, which is not limited herein;
wherein the marking icons may be icons such as numbers, letters and patterns printed on a white cardboard, and in practice, the icons such as the numbers, the letters and the patterns may be identified when identifying the marking icons;
wherein when determining the coordinate conversion relationship between one image collection apparatus and the world coordinate system each time, a plurality of marking icons may be placed within an image collection range of the image collection apparatus: or placement positions of the plurality of marking icons may be captured by a plurality of image collection apparatuses simultaneously, that is, the plurality of marking icons are located within the collection ranges of the plurality of image collection apparatuses.
Step S702: respectively determining image coordinates of a plurality of marking icons in the marked image, and determining world coordinates where the plurality of marking icons are located;
wherein the image coordinates of the plurality of marking icons in the marked image in the marked image may be identified, specifically, the image coordinates of the icons such as the numbers, the letters and the patterns in the marking icons may be identified, and reference may be made to the related art for a specific identification mode, which will not be described in detail herein; and
wherein the world coordinates where the plurality of marking icons are located may be measured by an on-site worker on site, and reflect real coordinate positions of the plurality of marking icons in the target scene, and specifically, the real coordinate positions may be three-dimensional coordinate positions, but a height coordinate in the three-dimensional coordinate positions may be set as 0 or 1.
Step S703: determining a first coordinate conversion parameter corresponding to each of the image collection apparatuses based on the image coordinates and the world coordinates.

In this example, the first coordinate conversion parameter may be calculated by utilizing a method for converting an image coordinate system of a camera head into a world global coordinate system in the related art based on the image coordinate of each of the plurality of marking icons in the marked image and the world coordinate of each of the plurality of marking icons in the world coordinate system, wherein the first coordinate conversion parameter may include eight position parameters.
Step S704; determining a second coordinate conversion parameter based on a world coordinate system and a coordinate system of a simulated image;
wherein since the simulated image is an equal-scale planar engineering drawing or three-dimensional stereogram of the target scene, the second coordinate conversion parameter may be obtained according to a scale relationship thereof.

Illustratively, by taking the planar engineering drawing as an example, an upper left corner point of the engineering drawing is appointed to be an origin of coordinates, a horizontal direction is an x-direction, and a vertical direction is a y-direction. The origin of coordinates, and x-axis and y-axis directions correspond to positions on the real world ground, and are an origin and a coordinate system in the world coordinate system.

The coordinate in the world coordinate system is set to be (x_{w1}, y_{w1}), a height of the entire region is set to be H meters (the y-direction), and a width is set to be W meters (the x-direction), so that the corresponding coordinate in the coordinate system of the engineering drawing is (x_{w2}, y_{w2}), the height is h meters, and the width is w meters.

Then:

$${x}_{w 2} = {x}_{w 1} \times \frac{w}{W} , and {y}_{w 2} = {y}_{w 1} \times \frac{h}{H} \qquad Equation ( 1 )$$

Thus, it is possible to obtain the coordinate of one object in the target scene in the simulated image when the object is mapped into the simulated image according to Equation (1);
wherein the drawing region selected by the region drawing operation on the scene image may be mapped to be the candidate region in the simulated image according to the first coordinate conversion parameter and the second coordinate conversion parameter. Specifically, firstly the world coordinate of the drawing region in the world coordinate system may be obtained according to the first coordinate conversion parameter, that is, the first region coordinate may be converted into the world region coordinate according to the first coordinate conversion parameter; and then the world coordinate of the drawing region is converted into the coordinate on the simulated image according to the second coordinate conversion parameter, namely, the world region coordinate is converted into the second region coordinate on the simulated image, and thus the candidate region on the simulated image is obtained;
wherein after obtaining the first coordinate conversion parameter and the second conversion parameter, the second conversion parameter is associated and stored with a corresponding simulated image based on associating and storing the first coordinate parameter with a corresponding image collection apparatus, and thus a coordinate conversion relationship among the image collection apparatuses (the first image collection apparatus and the second image collection apparatus)—the target scene—the simulated image is constructed, so that the coordinate conversion relationship may be directly called when performing subsequent region mapping; and
wherein after a plurality of image collection apparatuses (including the first image collection apparatus and the second image collection apparatus) are installed in the target scene, installation poses of one or more image collection apparatuses may change due to some situations, so that image collection ranges thereof deviates from original calibrated ranges; and in this case, due to the changes in the image collection ranges thereof, in this case, original image coordinate systems thereof change; and under the condition that the scene region is framed according to the original calibrated region, different regions may be framed out, which results in invalid information in subsequent processing and analysis of the image.

Thus, the first coordinate conversion parameter needs to be redetermined; and
wherein the contents of the above steps S701 to S703 may be adopted when redetermining the first coordinate conversion parameter of the image collection apparatus having the changed position. That is, the plurality of marking icons may be repositioned to enable the marking icons to be located within the collection range of the image collection apparatus after the pose changes. Of course, in some examples, under the condition that the poses of the plurality of marking icons are still located within the collection range of the image collection apparatus after the position changes, the first coordinate conversion parameter may be determined only by redetermining the image coordinates of the plurality of marking icons in the scene image by continuing to use the world coordinates of the plurality of marking icons.

During specific implementation, a world coordinate corresponding to each of a plurality of calibration points may be stored; when detecting that the pose of the image collection apparatus changes, the image collection apparatus having the changed pose is controlled to perform image collection again on the plurality of calibration points; then the first coordinate conversion parameter is updated based on the image coordinates of the plurality of calibration points in the marked image which are collected again and the stored world coordinate corresponding to each of the plurality of calibration points; and then the first coordinate conversion parameter corresponding to the image collection apparatus having the changed position is updated to the updated first coordinate conversion parameter;
wherein in this example, the image collection apparatus having the changed pose may be referred to as a third image collection apparatus, illustratively, under the condition that the pose of one first image collection apparatus changes, this first image collection apparatus is referred to as the third image collection apparatus, and under the condition that the pose of the second image collection apparatus changes, this second image collection apparatus is referred to as the third image collection apparatus; and
wherein in some examples, when the pose of the first image collection apparatus changes, under the condition that it is determined that the corresponding image collection range of the first image collection apparatus after the pose changes includes the region framed by the original calibrated region, the coordinate of the original calibrated region may be converted based on the existing image coordinate and the original image coordinate of the first image collection apparatus to obtain a new calibrated region of the first image collection apparatus, and then the new calibrated region is bound with the first image collection apparatus.

In some other examples, since the calibrated region is used for indicating a region in which objects to be identified need to be identified on the scene image, the coordinate system adopted by the calibrated region may be the image coordinate system of the image collection apparatus. Since the first coordinate conversion parameter exists between the image coordinate system and the world coordinate system, the calibrated coordinate of the calibrated region in the world coordinate system may be obtained, that is, the position of the calibrated region in the real world may be obtained. Thus, when the pose of the third image collection apparatus changes, as long as the image collection range thereof still includes the region framed by the calibrated region, a bridge of the image coordinate systems of the third image collection apparatus before and after the pose changes may be built by the world coordinate system, that is, the change of the calibrated region of the third image collection apparatus before and after the pose changes may be obtained according to the world coordinate system, so as to ensure that the calibrated region may correspond to the same region in the real scene before and after the pose of the third image collection apparatus changes, without recalibration for the changed third image collection apparatus.

During specific implementation, with reference to FIG. 8, a schematic flow diagram of steps of adjusting the calibrated region after a position of a third image collection apparatus changes is shown. As shown in FIG. 8, the following steps may be specifically included:
step S801: determining a calibrated coordinate of a calibrated region associated with an image collection apparatus in a world coordinate system based on a first coordinate conversion parameter.

In this example, since the calibrated region has the image coordinate in the image collection apparatus, the calibrated coordinate of the calibrated region in the world coordinate system may be obtained by utilizing the first coordinate conversion parameter, wherein the calibrated coordinate may include coordinates of a plurality of endpoints of the calibrated region, and in some cases, the calibrated coordinate may also include a coordinate of a central point of the calibrated region. Thus, an actual region of the calibrated region in the target scene may be determined.
Step S802: when detecting a third image collection apparatus having a changed pose, under the condition of determining that a scene image collected by the third image collection apparatus includes the associated calibrated region, updating a first coordinate conversion parameter corresponding to the third image collection apparatus;
wherein reference may be made to the above process for the process of updating the first coordinate conversion parameter corresponding to the third image collection apparatus, namely, the first coordinate conversion parameter is updated based on the image coordinates of a plurality of calibration points in the marked image collected again and the stored world coordinate corresponding to each of the plurality of calibration points.
Step S803: determining a calibrated region corresponding to the third image collection apparatus after a position changes based on the updated first coordinate conversion parameter and a calibrated coordinate corresponding to an initial calibrated region; and
step S804: associating the calibrated region corresponding to the third image collection apparatus after the position changes with the third image collection apparatus.

After the first coordinate conversion parameter of the third image collection apparatus is updated, a new conversion relationship between the image coordinate system of the third image collection apparatus after the pose changes and the world coordinate system is established, and thus the actual region of the calibrated region located in the target scene may be mapped back into the scene image collected by the third image collection apparatus after the pose changes again according to this new conversion relationship, so as to obtain the calibrated region in the newly collected scene image;
wherein the calibrated region corresponding to the third image collection apparatus after the pose changes is actually still aimed at the same region in the target scene as the calibrated region corresponding to the third image collection apparatus before the position changes, only the shape or position in the scene image collected by the third image collection apparatus after the pose changes is different, but the calibrated region contains valid information and contains no or less invalid information; and
wherein the pose change may refer to a position change, an angle change, and the like, and any change which may affect the image collection range may be referred to as the pose change.

Since when the position of the image collection apparatus changes, the conversion relationship between the changed image coordinate system of the image collection apparatus and the world coordinate system may be obtained based on the first coordinate conversion parameter obtained after the change, while the calibrated region generally represents a fixed region in the real scene after being calibrated, and thus the position, size and shape of the fixed region on the shot image may also change after the position of the image collection apparatus changes.

In this example, the fixed region in the real scene may be directly mapped back into the scene image collected after the position changes according to the updated first coordinate conversion parameter, and a new size and a new position of the calibrated region in the scene image collected after the position changes are obtained, so as to migrate the calibrated region before the position changes into the scene image collected after the position changes, thereby avoiding manual recalibration of the calibrated region of the image collection apparatus having the changed position, and saving the expenditure of labor costs in the case where the recalibration is not needed since the recalibration needs to be performed by an on-site worker; and
wherein in some examples, the region drawing operation may include touch control, single click operation, and the like on a plurality of position points on the scene image, and may also include line drawing operation on the scene image, wherein the position points being subjected to the touch control or single click may be understood to be endpoints of the region to be selected, and the drawn lines may be understood to be edges of the region to be selected.

During specific implementation, a closed image region may be generated on the scene image in response to a plurality of position points where preset operation is executed on the scene image, and/or a plurality of lines drawn on the scene image; and then the candidate region into which the closed image region is mapped is displayed in the simulated image.

In a specific implementation of this example, the single click or touch control on the position points and the drawing of the lines may be performed simultaneously on the scene image, and in this case, the image region may be fitted according to the plurality of position points triggered and the drawn lines.

In a specific implementation of this example, only the single click or touch control on the position points may be performed on the scene image, and in this case, a plurality of position points may be connected into the closed image region by utilizing preset lines according to the plurality of position points triggered.

In a specific implementation of this example, only the drawing operation on the lines may be performed on the scene image, and in this case, a plurality of lines may be subjected to processing such as smoothing according to the plurality of lines drawn, so as to fit the closed image region.

When such an implementation mode is adopted, it may be convenient for the on-site worker to draw a drawing region on the scene image to optimize the region drawing experience of the on-site worker.

The region calibration method of the disclosure is completely described below by way of an instance:
by taking FIG. 1 as an example, the following flow is specifically included:
when statistics on guest traffic of a storefront of a furniture store needs to be performed, an on-site worker arrives at the storefront to perform calibration on site, and may carry a standby camera and four marking icons, the standby camera is used for adding a camera to the storefront, and a first electronic device is utilized for assisting in completing calibration work, wherein a system may run in the first electronic device, and the system may include a region calibration module for calibrating a calibrated region of the camera in the store.
S1: starting calibration of a coordinate of each of the cameras of the storefront; specifically including:
S11: placing the four marking icons within a range where a camera i may collect an image, then acquiring the image shot by the camera i, and starting measurement of world coordinates of the marking icons at placement positions; wherein the camera i is any one of a plurality of cameras, and i is greater than or equal to 1 and less than or equal to a total quantity of the cameras;
S12: inputting the acquired image into a neural network model to obtain image coordinates of the four marking icons in the image, and obtain a total of four image coordinates;
S13: calculating a conversion matrix parameter based on the image coordinates to the world coordinates, namely, a first coordinate conversion parameter by utilizing four image coordinates and four world coordinates according to an existing method for converting an image coordinate system of the camera into a world global coordinate system, wherein the conversion matrix parameter includes eight position parameters, and exists in a coordinate conversion file corresponding to the camera i;
S14: simulating a simulated image of the furniture store, wherein the simulated image may be a planar engineering drawing of the furniture store herein, and is in an equal-scaling relationship with a real furniture store, and thus a coordinate conversion relationship between a coordinate system of the planar engineering drawing and a world coordinate system, namely, a second coordinate conversion parameter, may be obtained; and
thus, the calibration work of all of the cameras is completed, and the on-site worker may upload the first coordinate conversion parameter and the second coordinate conversion parameter into the system to be used by a subsequent system for performing region calibration, wherein the system may be located in a computer device of the furniture store, may be downloaded in advance, and may also be downloaded by the on-site worker.
S2: importing the camera in the store into the system, so that the system may acquire and exhibit a scene image shot by the camera;
S3: displaying the scene image shot by the camera i in a system interface, wherein specifically, the system interface may be a first image drawing interface aimed specially at drawing of the scene image, and then drawing a region not including invalid information from the scene image by the on-site worker according to drawing tools provided by the first image drawing interface;
S4: automatically mapping the drawn region into the planar engineering drawing according to the first coordinate conversion parameter and the second coordinate conversion parameter corresponding to the camera i by the system to obtain a candidate region i located in the planar engineering drawing;
wherein through the above step S3 and step S4, the candidate regions of all of the cameras in the plan engineering drawing may be obtained, and assuming that there are a total of N cameras, N candidate regions may be obtained;
S5: adjusting the candidate regions on the planar engineering drawing in a second image drawing interface, and specifically, under the condition that there are a plurality of candidate regions having overlaps in the N candidate regions, adjusting shapes or sizes of the candidate regions having the overlaps, so that no overlap exists between the plurality of candidate regions;
S6: mapping the adjusted candidate region i back into the first image drawing interface, and displaying the adjusted candidate region i in the scene image of the camera i; under the condition that it is determined that the adjusted candidate region i is still located in the scene image of the camera i, and does not include invalid information, taking the adjusted candidate region i as a calibrated region of the camera i; and otherwise, continuing to execute the step S4 and step S5;
S7: determining whether the calibrated regions of the existing N cameras of the store completely cover the planar engineering drawing; and
if so, entering step S8, and if no, entering steps S9 to S10:
S8: when the calibration work is finished, the calibrated region corresponding to each of the cameras may be saved, for example, returned to the camera, so that the scene image sent out by the camera carries the image coordinate of the calibrated region, so as to indicate that only the calibrated region is identified; or the calibrated region may be stored in the system and called when the image collected by the camera comes;
S9: displaying an uncovered region which is not covered by the calibrated region in the second image drawing interface, pre-installing a camera k (from a carried standby camera or a camera self-provided by a merchant) by the on-site worker at a candidate position S in the store, displaying a picture collected by the camera k in the first image drawing interface, and mapping all of regions included in the picture into the planar engineering drawing;
performing picture interception on the second image drawing interface by the system, wherein the picture obtained by the picture interception includes a picture region collected by the camera k and the uncovered region, and then displaying the picture obtained by the picture interception into a portable display device carried by the on-site worker;
under the condition that it is determined that the image region collected by the camera k covers the uncovered region, installing the camera k at the position S; and if not, adjusting the position of the camera K, and repeating the above steps until a specific installation pose is determined; and
S10: after the position of the camera k is determined, directly returning the uncovered region to the camera K as the calibrated region of the camera K, or the region may be calibrated for the camera K according to the processes of the above steps S3 to S4.

Of course, generally, it is not necessary to require the camera to completely cover the region of the store according to the requirements of the store, and therefore, in practice, the processes of S9 to S10 may not be performed, but an old camera of the merchant may be directly utilized for completing this new function.

### Example 2

Based on the same inventive concept, the disclosure further provides an information processing method. The information processing method utilizes the calibrated region of each of image collection apparatuses determined by the above region calibration method, so that only the calibrated region in the scene image collected by the image collection apparatus needs to be identified, thereby avoiding the identification of invalid information.

With reference to FIG. 9, a schematic flow diagram of steps of the information processing method is shown. The method may be applied in a second electronic device, and it should be noted that the second electronic device may be located in the target scene or not located in the target scene. Generally, the second electronic device may be a device for identifying an object to be identified, the second electronic device may be the same device as the first electronic device or may be a different device. In the case of different devices, the first electronic device may communicate with the second electronic device, and the calibrated regions corresponding to a plurality of image collection apparatuses are sent to the second electronic device, wherein the second electronic device and the first electronic device may be communicatively connected to the plurality of image collection apparatuses respectively, so as to execute the information processing method.

Specifically, as shown in FIG. 9, the following steps are included:
step S901: respectively acquiring scene images collected by a plurality of image collection apparatuses on a target scene, and calibrated regions respectively corresponding to the plurality of image collection apparatuses; wherein the calibrated regions are determined according to the region calibration method of the above Example 1;
step S902: identifying objects to be identified in target regions of the scene images to obtain target information; wherein the target regions are regions framed by the calibrated regions; and
step S903: executing information processing corresponding to a scene task on each piece of the target information, wherein the scene task is a task corresponding to the target scene.

In this example, the plurality of image collection apparatuses may be located in the target scene, may include a first image collection apparatus, and may also include a newly added second image collection apparatus; wherein the plurality of image collection apparatuses may execute an image collection task after the calibrated regions are calibrated, and in the image collection task, the scene image collected for the target scene may be sent to the second electronic device;
wherein since the plurality of image collection apparatuses respectively correspond to the respective calibrated regions, and the calibrated regions are drawn on site according to requirements and contain no or less invalid information, when objects to be identified in the scene image are identified, only the objects to be identified in regions framed by the calibrated regions may be identified, so as to avoid the interference of the invalid information in the scene image and an increase in the calculation amount, thereby improving the efficiency and accuracy of calculation;
wherein the objects to be identified may be determined according to the requirements of information processing, for example, in analysis of guest traffic, the objects to be identified may be human bodies, and in analysis of trajectories and distribution density of robots, the objects to be identified may be robots. Of course, in some other scenes, the objects to be identified may be of other types, which is not limited herein; and
wherein the scene task is a task required in the target scene, and under the condition that the target scene is the furniture store, the scene task may be a guest traffic analysis task, and corresponding information processing may be analysis of a quantity, density and the like of the human bodies in the store.

Of course, the information processing may also be different according to different scene tasks, and the identification of the objects to be identified may also be different. In practice, regardless of the type of the scene task, since each of the image collection apparatuses may calibrate the calibrated region according to the scene task, in execution of the scene task, the analysis and processing of the invalid information may be avoided, thereby improving the processing efficiency.

In this example, the acquisition mode of the calibrated region may include the following two types:
mode 1: the calibrated region corresponding to a current image collection apparatus is determined from a preset calibrated region library; wherein the preset calibrated region library stores a region coordinate of the calibrated region corresponding to each of a plurality of image collection apparatuses.

When the mode 1 is adopted, the first electronic device may feed back the coordinate of the calibrated region corresponding to each of the image collection apparatuses in the scene image to the second electronic device, and the second electronic device stores the coordinate in the preset calibrated region library; or the first electronic device directly stores the coordinate of the calibrated region corresponding to each of the image collection apparatuses in the scene image into the preset calibrated region library, the preset calibrated region library may be shared by the first electronic device and the second electronic device, and thus the second electronic device may directly call the calibrated region corresponding to the current image collection apparatus from the preset calibrated region library.

It should be noted that the current image collection apparatus may be either the first image collection apparatus or the second image collection apparatus.

Mode 2: the calibrated region is determined based on a region coordinate carried in the image collected by the image collection apparatus.

When the mode 2 is adopted, the first electronic device may feed back the coordinate of the calibrated region corresponding to each of the image collection apparatuses in the scene image to this image collection apparatus, so that when one scene image is collected by the image collection apparatus, the coordinate of the calibrated region in the scene image is carried in an image file, and the second electronic device parses the coordinate from the image file to obtain the framed target region, and then identifies objects to be identified in the target region; and
wherein the above mode 1 and mode 2 may be used in combination, and under the condition that the calibrated region is not acquired from the preset calibrated region library, the calibrated region is acquired from the region coordinate carried by the image. That is, the coordinate of the calibrated region in the scene image may be carried in the scene image, and may also be stored in the preset calibrated region library for the second electronic device to call.

In some examples, target information may include position information of the object to be identified, and the scene task may include: a position display task and/or an object statistics task, and when performing information processing corresponding to the scene task on each piece of position information, the following processing may be included:
processing 1: in the case where the scene task is the position display task, each piece of position information is mapped into the simulated image for simulating the target scene for display; and
in such processing, the position of the object to be identified in the target region may be identified to obtain the position information, wherein the position may be the position of the object to be identified in the scene image; and in practice, the position information of the object to be identified may be displayed in the simulated image, and then the position of the object to be identified in the scene image may be mapped into the simulated image for display.

In one instance, a third drawing interface may be provided, the simulated image of the target scene may be displayed in the third drawing interface, and the third drawing interface provides a plurality of image display functions, wherein different image display functions may perform different processing on the position information, for example, perform the above processing 1 and processing 2, and a processed result is displayed into the simulated image in the third drawing interface; and specifically, a plurality of layers may also be provided in the third drawing interface, wherein the simulated image is located in one layer, while the processed result may be located in another layer for display.

By adopting the mode of processing 1, the position of the object to be identified in each of the target regions may be directly displayed in the simulated image, and the position distribution of the objects to be identified entering the target scene in each of regions of the target scene may be more intuitively understood. In some instances in this mode, the position of the object to be identified in each of the target regions may be mapped to a corresponding position in the simulated image for display in response to a first image display function triggered on the third drawing interface, wherein the layer in which the position information is located may be different from the layer in which the simulated image is located during display.

Of course, in this instance, the position information of each of the objects to be identified which is identified at the current time may be mapped into the simulated image for display at an interval of preset time in response to the first image display function triggered on the third drawing interface, and thus a live condition of the object to be identified in the target scene may be displayed on the simulated image.

Processing 2: in the case where the scene task is the object statistics task, statistics on a plurality of pieces of position information is performed to obtain statistical information, and the statistical information is rendered in the simulated image.

In some instances in this mode, statistics on the position information of the object to be identified in each of the target regions may be performed in response to a second image display function triggered on the third drawing interface, so that a statistical result is rendered at a corresponding position in the simulated image for display, wherein the layer in which the statistical result is located may be different from the layer in which the simulated image is located during display.

In such processing 2, statistics on the position of the object to be identified in the target region may also be performed according to a corresponding dimension to obtain statistical information under the corresponding dimension, wherein the statistical information may be rendered in the simulated image, so that the statistical result may be observed intuitively from the simulated image.

Specifically, in processing 2, since it is necessary to perform statistics on the positions of the objects to be identified which are identified in a plurality of scene images, the statistical information is obtained, wherein the statistics include a statistical dimension according to the objects and a statistical dimension according to the calibrated region; and
wherein the statistical dimension according to the objects may mean that statistics on the position information of the same object to be identified which is identified in the plurality of scene images is performed to obtain trajectory information of the same object to be identified.

In this dimension, the plurality of scene images may be different scene images, or the plurality of scene images may include different scene images, and may also include the same scene images, wherein since different scene images are collected by different image collection apparatuses, different image collection apparatuses correspond to different calibrated regions, namely, correspond to different regions in the target scene, and thus movement trajectories of the object to be identified in different regions (calibrated regions) in the target scene may be obtained by performing statistics on the position information of the same object to be identified which is identified in different scene images, wherein under the condition that the plurality of scene images include different scene images and also include the same scene images, the movement trajectory of the same object to be identified at each of different position points in the target scene may be obtained; and
wherein during statistics, the positions of the same object to be identified in the respective corresponding regions may be sorted according to time, namely, according to the collection time of the scene images, so as to obtain a plurality of position points sorted according to the time order, and the plurality of position points are mapped into the simulated image to obtain the trajectory information.

Specifically, in a further instance, statistics on the position information of the same object to be identified which is identified in a plurality of scene images may be performed in response to a first sub-statistical function under the second image display function on the third drawing interface to obtain the trajectory information of the same object to be identified, so as to map each of trajectory points in the trajectory information to a corresponding position in the simulated image for display; and
wherein the statistical dimension according to the calibrated region may mean that statistics on each piece of position information is performed according to the calibrated region in which the position represented by the position information is located to obtain quantity information of the objects to be identified in different calibrated regions.

In this dimension, since different scene images are collected by different image collection apparatuses, and different image collection apparatuses correspond to different calibrated regions, a plurality of scene images collected by the same image collection apparatus within a preset time period may be obtained, and the quantity of the objects to be identified in the plurality of scene images is identified, so as to obtain the quantity of the objects to be identified in the calibrated region of the image collection apparatus, and so on, the quantity of the objects to be identified in each of a plurality of calibrated regions within the preset time period may be obtained, so as to obtain the quantity information of the objects to be identified in different calibrated regions.

Specifically, in a still further instance, statistics on each piece of position information in each of the calibrated regions may be performed according to the calibrated region in which the position represented by the position information is located in response to a second sub-statistical function under the second image display function on the third drawing interface to obtain quantity information of the objects to be identified in different calibrated regions, and then the quantity information of the objects to be identified is displayed in the different calibrated regions in a thermodynamic diagram mode in the simulated image.

In such statistics, the quantity information corresponding to the different calibrated regions may be displayed in the thermodynamic diagram mode in the simulated image, so that the user directly observes the heat of the different calibrated regions. Illustratively, by taking statistics on guest traffic as an example, it may be intuitively understood which regions are popular and are welcomed by customers through the thermodynamic diagram.

In some examples, the objects to be identified may be human bodies and thus may be applied in statistics on the guest traffic of the store, and positions of the human bodies need to be identified, wherein the purpose of the statistics on the guest traffic may be achieved by identifying positions of feet of the human bodies. Since the feet of the human bodies may reflect real positions of the human bodies in a real scene, the accuracy of identification may be improved.

During specific implementation, firstly the feet of the human body in the target region may be detected; under the condition that the feet are detected, the positions of the feet are identified; and under the condition that the feet are not detected, the positions of the feet are predicted based on a position of at least one target part of the human body;
wherein the target part is a part in the human body other than the feet;
wherein other parts may include a head, a trunk, limbs, and the like. In order to ensure the prediction accuracy of the positions of the feet, the more the other parts are, the more accurate the prediction is;
wherein related technologies may be adopted in the mode for detecting the feet of the human body, for example, the feet of the human body in the target region is detected by utilizing a neural network, and in this mode, only a plurality of image samples containing the feet of the human body are utilized as training samples to train a neural network model capable of identifying the feet of the human body, and then the target region in the scene image is clipped out and sent into the neural network model to obtain a detection result of the feet;
wherein when the feet are detected, the positions of the feet in the scene image may be further detected to obtain position information, and the positions of the feet may also be mapped back into the simulated image for display.

Under the condition that the feet are not detected, the positions of the feet may be predicted according to the position, size, and the like of other parts of the human body other than the feet in the scene image. Further, the other parts may include the head and the trunk, then a posture of the human body may be determined according to a positional relationship between the position of the head and the position of the trunk, and the detected size of the head and size of the trunk, and thus the positions of the feet of the human body are predicted.

During specific implementation, a head position of the human body and a body position of the human body in the target region may be detected when the positions of the feet are predicted based on the position of at least one target part of the human body; then a posture category of the human body is determined based on the head position and/or the body position; and then the positions of the feet are predicted based on the posture category;
wherein the posture category may reflect the posture of the human body.

In practice, the above neural network model may also detect the head of the human body and the body of the human body simultaneously, and may detect the head position of the human body and the body position of the human body. In practice, the neural network model may be selected from existing models in the related art, which will not be described in detail herein.

Further, when detecting a head position box where a head is located and a body position box where a body is located, the posture category may be determined based on a size ratio between the head position box and the body position box; and in the case where only the head position box or the body position box is detected, the posture category may be determined as a preset category corresponding to the detected position box; and
wherein the posture category may include three categories, namely, standing, squatting and sitting, and size ratio values of the head and the body of the human body are different in different categories. In practice, the size ratio values of the head and the body of different people in different posture categories may be obtained according to a plurality of experiments, then comprehensive ratio values of the head and the body of the human body in different posture categories may be estimated, and the comprehensive ratio values are used for measuring the posture category of the human body, wherein each of the posture categories may correspond to a preset positional relationship between one foot position and the head position and the body position respectively, and the foot position may be obtained through the head or body position by utilizing the preset relationship.

Thus, when detecting the head position box where the head is located and the body position box where the body is located, the posture category may be obtained according to the size ratio between the head position box and the body box as well as the comprehensive ratio value, and then the foot position may be obtained according to the position of the head position box or the body position box and the preset positional relationship corresponding to the posture category;
wherein under the condition that the head position box where the head is located is not detected and the body position box where the body is located is detected, the posture category may be directly determined as the standing category, and the foot position is determined according to the preset positional relationship corresponding to the standing category and the position of the body box; and
wherein under the condition that the head position box where the head is located is detected and the body position box where the body is located is not detected, the posture category may be directly determined as the standing category, and the foot position is determined according to the preset positional relationship corresponding to the standing category and the position of the body box.

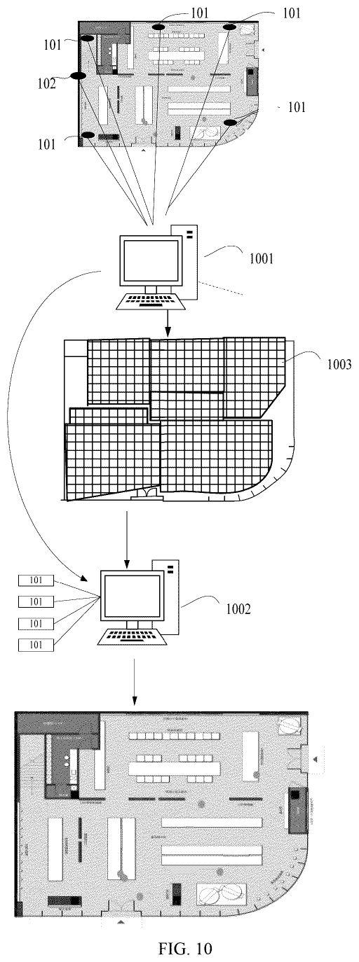

The region calibration method and the information processing method of the disclosure are completely described below in conjunction with one instance:
by taking FIG. 1 as an example, assuming that a target scene is a furniture store, and statistics on guest traffic in the furniture store needs to be performed, with reference to FIG. 10, a schematic flow diagram of this instance is shown, in FIG. 10, 101 is a first image collection apparatus, 102 is a second image collection apparatus, and specifically the following flow is included:
a worker arrives at a storefront and calibrates a calibrated region corresponding to each of cameras in the storefront in a region calibration module provided by a system by utilizing a first electronic device 1001 provided by the storefront.
S1: placing four marking icons within a range where a camera i may collect an image, then acquiring the image shot by the camera i, and starting measurement of world coordinates of the marking icons at placement positions; wherein the camera i is any one of a plurality of cameras, and i is greater than or equal to 1 and less than or equal to a total quantity of the cameras;
S2: inputting the acquired image into a neural network model to obtain image coordinates of the four marking icons in the image, and obtain a total of four image coordinates;
S3: calculating a conversion matrix parameter based on the image coordinates to the world coordinates, namely, a first coordinate conversion parameter by utilizing four image coordinates and four world coordinates according to an existing method for converting an image coordinate system of the camera into a world global coordinate system, wherein the conversion matrix parameter includes eight position parameters, and exists in a coordinate conversion file corresponding to the camera i;
S4: simulating a simulated image of the furniture store, wherein the simulated image may be a planar engineering drawing of the furniture store herein, and is in an equal-scaling relationship with a real furniture store, and thus a coordinate conversion relationship between a coordinate system of the planar engineering drawing and a world coordinate system, namely, a second coordinate conversion parameter, may be obtained; and
thus, the calibration work of all of the cameras is completed, and the on-site worker may upload the first coordinate conversion parameter and the second coordinate conversion parameter into the system to be used by a subsequent system for performing region calibration, wherein the system may be located in a computer device of the furniture store, may be downloaded in advance, and may also be downloaded by the on-site worker.
S5: importing the camera in the store into the system, so that the system may acquire and exhibit a scene image shot by the camera;
S6: displaying the scene image shot by the camera i in a system interface, wherein specifically, the system interface may be a first image drawing interface aimed specially at drawing of the scene image, and then drawing a region not including invalid information from the scene image by the on-site worker according to drawing tools provided by the first image drawing interface;
S7: automatically mapping the drawn region into the planar engineering drawing according to the first coordinate conversion parameter and the second coordinate conversion parameter corresponding to the camera i by the system to obtain a candidate region i located in the planar engineering drawing;
wherein through the above step S3 and step S4, the candidate regions of all of the cameras in the plan engineering drawing may be obtained, and assuming that there are a total of N cameras, N candidate regions 1003 may be obtained;
S8: adjusting the candidate regions on the planar engineering drawing in a second image drawing interface, and specifically, under the condition that there are a plurality of candidate regions having overlaps in the N candidate regions, adjusting shapes or sizes of the candidate regions having the overlaps, so that no overlap exists between the plurality of candidate regions;
S9: mapping the adjusted candidate region i back into the first image drawing interface, and displaying the adjusted candidate region i in the scene image of the camera i; under the condition that it is determined that the adjusted candidate region i is still located in the scene image of the camera i, and does not include invalid information, taking the adjusted candidate region i as a calibrated region of the camera i; and otherwise, continuing to execute the step S4 and step S5;
S10: determining whether the calibrated regions of the existing N cameras of the store completely cover the region contained in valid information;
S11: if so, the calibration work is finished, the coordinate of the calibrated region corresponding to each of the cameras in the image coordinate system may be returned to the camera, so that the scene image sent out by the camera carries the image coordinate of the calibrated region;
S12: if not, an uncovered region which is not covered by the calibrated region is displayed in the second image drawing interface, wherein the uncovered region herein may refer to a region in which valid information is not covered;
pre-installing a camera k (from a carried standby camera or a camera self-provided by a merchant) by the on-site worker at a candidate position S in the store, displaying a picture collected by the camera k in the first image drawing interface, and mapping all of regions included in the picture into the planar engineering drawing;
performing picture interception on the second image drawing interface by the system, wherein the picture obtained by the picture interception includes a picture region collected by the camera k and the uncovered region, and then displaying the picture obtained by the picture interception into a portable display device carried by the on-site worker;
under the condition that it is determined that the image region collected by the camera k covers the uncovered region, installing the camera k at the position S; and if not, adjusting the position of the camera K, and repeating the above steps until a specific installation pose is determined;
S13: after the position of the camera k (102 in FIG. 10) is determined, directly returning the uncovered region to the camera K as the calibrated region of the camera K, or the region may be calibrated for the camera K according to the processes of the above steps S5 to S8.

Next, staff of the storefront starts a guest traffic statistics module in the system, and starts statistics on guest traffic; and the second electronic device 1002 may be utilized, and in the case where the first electronic device 1001 and the second electronic device 1002 are the same device, a user may log in the guest traffic statistics module in the system to perform statistics on the guest traffic, including:
S14: acquiring scene images collected by a plurality of image collection apparatuses on a target scene in real time;
S15: identifying foot positions of a human body in a region framed by a calibrated region in each of the scene images; and
S16: mapping a quantity of feet of the human body identified in a plurality of scene images collected by each of different image collection apparatuses into a simulated image, wherein the quantity of the feet may be reflected in the simulated image by heat, so as to form a statistical thermodynamic diagram of the guest traffic, as shown in FIG. 10, and the statistical thermodynamic diagram is represented by an origin distribution density.

Based on the same inventive concept, the disclosure further provides a region calibration apparatus, and with reference to FIG. 11, a schematic structural diagram of the region calibration apparatus is shown. The region calibration apparatus may specifically include the following modules:
a display module 1101 configured to display a scene image collected by each of at least one first image collection apparatus located in a target scene, wherein the first image collection apparatus is used for performing image collection on part or all of regions in the target scene;
a drawing module 1102 configured to display a candidate region selected by region drawing operation in a simulated image for simulating the target scene in response to the region drawing operation performed on the scene image;
a determination module 1103 configured to determine a calibrated region corresponding to each of a plurality of first image collection apparatuses based on the candidate region corresponding to each of the first image collection apparatuses; wherein no overlap exists between at least two adjacent calibrated regions; and
an association module 1104 configured to respectively associate a plurality of calibrated regions with the plurality of first image collection apparatuses to indicate identification of objects to be identified in image regions framed by the calibrated regions in images collected by the first image collection apparatuses.

Optionally, the determination module 1103 is specifically configured to:
determine the calibrated region corresponding to each of the plurality of first image collection apparatuses in response to region adjustment operation on part or all of the candidate regions in a plurality of candidate regions; or
adaptively adjust each of the candidate regions based on an overlapping region between each of the candidate regions in the simulated image to obtain the calibrated region corresponding to each of the plurality of first image collection apparatuses.

Optionally, the apparatus further includes:
a first mapping module configured to map the adjusted candidate region into the scene image from which the adjusted candidate region originates for display;
a repetition module configured to: when receiving modification operation on the adjusted candidate region in the scene image, display a region corresponding to the modification operation in the simulated image, and repeat the step of determining a calibrated region corresponding to each of a plurality of first image collection apparatuses based on the candidate region corresponding to each of the first image collection apparatuses; and
determination of the calibrated region includes: when receiving determination operation for the adjusted candidate region, taking the adjusted candidate region as the calibrated region of the corresponding first image collection apparatus.

Optionally, the drawing module 1102 includes:
an overlapping region determination unit configured to determine an overlapping region of each of the candidate regions on the simulated image; and
a display unit configured to display each of the candidate regions, and the overlapping region of each of the candidate regions.

Optionally, the apparatus further includes:
an uncovered region display module configured to display an uncovered region in the simulated image: wherein the uncovered region includes a region not covered by the candidate region, or a region not covered by the calibrated region; and
a pose determination module configured to determine an installation pose of a second image collection apparatus in the target scene based on the uncovered region, and take part or all of the uncovered region as a calibrated region of the second image collection apparatus;
wherein the second image collection apparatus is used for being newly added to the target scene to collect an image of the uncovered region.

Optionally, the pose determination module includes:
a target image acquisition unit configured to acquire a target image obtained by the second image collection apparatus performing image collection on the target scene at a candidate position;
a collection region determination unit configured to map a scene region included in the target image into the simulated image to obtain a collection region;
an information output unit configured to output position adjustment information based on the collection region and the uncovered region; and
a pose determination unit configured to determine the installation pose based on the position adjustment information.

Optionally, the information output unit includes:
a type determination subunit configured to determine a type of coverage of the collection region covering the uncovered region;
an information generation subunit configured to generate the position adjustment information based on the type of coverage; wherein the position adjustment information includes a movement direction and/or a movement distance of the candidate position of the second image collection apparatus; and
an information sending subunit configured to send the position adjustment information to a user side.

Optionally, the information output unit includes:
a picture interception subunit configured to perform picture interception on the simulated image displaying the collection region and the uncovered region; and
a sending subunit configured to send an intercepted picture to the user side as the position adjustment information.

Optionally, the drawing module 1102 includes:
a first coordinate acquisition unit configured to determine a first region coordinate of a drawing region selected by the region drawing operation on the scene image in response to the region drawing operation;
a second coordinate acquisition unit configured to convert the first region coordinate into a second region coordinate on the simulated image; and
a mapping unit configured to map the drawing region onto the simulated image based on the second region coordinate to obtain the candidate region.

Optionally, the drawing module 1102 includes:
an image region generation unit configured to generate a closed image region on the scene image in response to a plurality of position points where preset operation is executed on the scene image, and/or a plurality of lines drawn on the scene image; and
an image region mapping unit configured to display the candidate region into which the closed image region is mapped in the simulated image.

Optionally, the apparatus further includes:
a marked image acquisition module configured to acquire a marked image collected by an image collection apparatus, wherein the marked image includes images of a plurality of marking icons located in the target scene; and the image collection apparatus includes the first image collection apparatus and the second image collection apparatus;
an image coordinate acquisition module configured to respectively determine image coordinates of the plurality of marking icons in the marked image, and determine world coordinates where the plurality of marking icons are located;
a first conversion module configured to determine a first coordinate conversion parameter corresponding to each of the image collection apparatuses based on the image coordinates and the world coordinates; and
a second conversion module configured to determine a second coordinate conversion parameter based on a world coordinate system and a coordinate system of the simulated image; wherein the first coordinate conversion parameter and the second coordinate conversion parameter are used for mapping an image region selected by the region drawing operation on the scene image into a candidate region in the simulated image.

Optionally, the apparatus further includes:
a calibrated coordinate storage module configured to determine a calibrated coordinate of a calibrated region associated with the image collection apparatus in the world coordinate system based on the first coordinate conversion parameter;
a parameter updating module configured to: when detecting a third image collection apparatus having a changed pose, updating a first coordinate conversion parameter corresponding to the third image collection apparatus under the condition that it is determined that a scene image collected by the third image collection apparatus includes an associated calibrated region;
a region updating module configured to determine a calibrated region corresponding to the third image collection apparatus after the pose changes based on the updated first coordinate conversion parameter and a calibrated coordinate corresponding to the third image collection apparatus; and
a region association module configured to associate the calibrated region corresponding to the third image collection apparatus after a position changes with the third image collection apparatus.

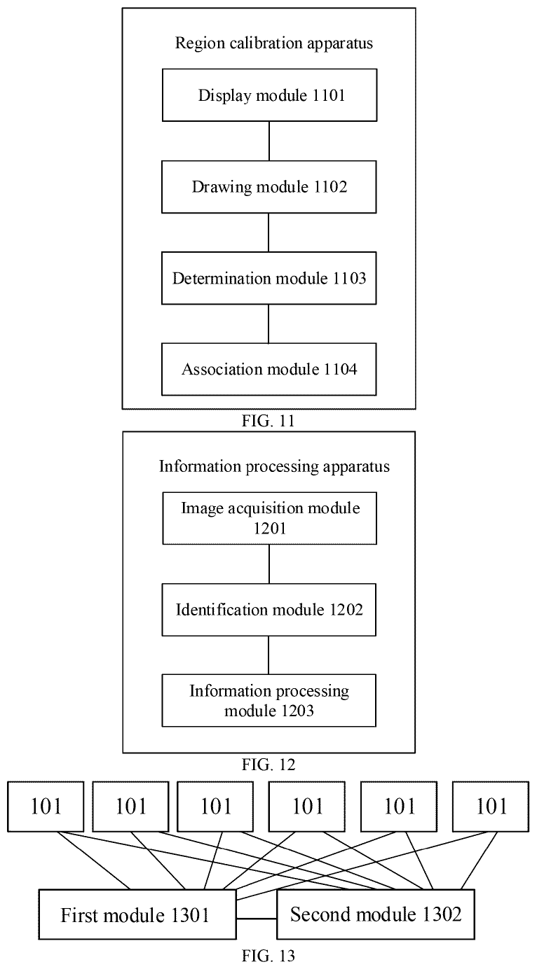

Based on the same inventive concept, the disclosure further provides an information processing apparatus, and with reference to FIG. 12, a schematic structural diagram of the information processing apparatus. The information processing apparatus may specifically include the following modules:
an image acquisition module 1201 configured to respectively acquire scene images collected by a plurality of image collection apparatuses on a target scene, and calibrated regions respectively corresponding to the plurality of image collection apparatuses; wherein the calibrated regions are determined by the region calibration method;
an identification module 1202 configured to identify objects to be identified in target regions of the scene images to obtain target information; wherein the target regions are regions framed by the calibrated regions; and
an information processing module 1203 configured to execute information processing corresponding to a scene task on each piece of the target information, wherein the scene task is a task corresponding to the target scene.

Optionally, the information processing module 1203 is specifically configured to execute information processing corresponding to a target image display function on each piece of the target information in response to the target image display function triggered on a third drawing interface, and display a processing result of the information processing on a simulated image for simulating the target scene;
wherein a plurality of image display functions are preset on the third drawing interface, and different image display functions correspond to different scene tasks.

Optionally, the target information includes position information of the objects to be identified, and the scene task includes: a position display task and/or an object statistics task. The information processing module 1203 includes:
a first processing unit configured to: in the case where the scene task is the position display task, map each piece of the position information into the simulated image for simulating the target scene for display; and
a second processing unit configured to: in the case where the scene task is the object statistics task, perform statistics on a plurality of pieces of position information to obtain statistical information, and render the statistical information in the simulated image.

Optionally, the second processing unit is configured to execute steps including at least one of:
performing statistics on position information of the same object to be identified which is identified in the plurality of scene images to obtain trajectory information of the same object to be identified; and
performing statistics on each piece of position information according to the calibrated region in which the position represented by the position information is located to obtain quantity information of the objects to be identified in different calibrated regions.

Optionally, the objects to be identified are human bodies, and the identification module 1202 includes:
a detection unit configured to detect feet of the human body in the target region;
a first identification unit configured to: under the condition that the feet are detected, identify positions of the feet; and
a second identification unit configured to: under the condition that the feet are not detected, predict the positions of the feet based on a position of at least one target part of the human body; wherein the target part is a part in the human body other than the feet.

Optionally, the second identification unit is specifically configured to execute the following steps:
detecting a head position of the human body and a body position of the human body in the target region;
determining a posture category of the human body based on the head position and/or the body position; and
predicting the positions of the feet based on the posture category.

Optionally, the step of detecting a head position of the human body and a body position of the human body in the target region, includes:
detecting a head position box where a head is located and a body position box where a body is located:
the determining a posture category of the human body based on the head position and/or the body position, includes:
in the case where the head position box and the body position box are detected, determining the posture category based on a size ratio between the head position box and the body position box; and
in the case where the head position box or the body position box is detected, determining the posture category as a preset category corresponding to the detected position box.

Optionally, the step of determining calibrated regions respectively corresponding to the plurality of image collection apparatuses, includes:
determining a calibrated region corresponding to a current image collection apparatus from a preset calibrated region library; wherein a region coordinate of the calibrated region corresponding to each of a plurality of image collection apparatuses is stored in the preset calibrated region library; or
determining the calibrated region based on the region coordinate carried in the scene image collected by the image collection apparatus.

Based on the same inventive concept, the disclosure further provides an information processing system, and with reference to FIG. 13, a schematic frame diagram of the information processing system is shown. The information processing system includes: a first module 1301, a second module 1302, and a plurality of image collection apparatuses 101 located in a target scene; wherein the first module and the second module are both connected to the plurality of image collection apparatuses;
wherein the first module is configured to execute the region calibration method; and
the second module is configured to execute the information processing method based on a calibrated region corresponding to each of the image collection apparatuses;
wherein the first module is configured to send the calibrated region corresponding to each of a plurality of image collection apparatuses to the second module; and/or
configured to return the calibrated region corresponding to each of a plurality of image collection apparatuses to the image collection apparatus; and
wherein the first module may be one functional module in one system, and the second module may also be one functional module in one system; or the first module may be one electronic device, such as the first electronic device, and the second module may be one electronic device, such as the second electronic device.

Based on the same inventive concept, the disclosure further provides an electronic device, including a memory, a processor, and a computer program stored on the memory and capable of running on the processor, wherein the processor implements the region calibration method according to Example 1, or the information processing method according to Example 2 during execution.

An example of the disclosure further provides a computer-readable storage medium, wherein a computer program stored therein causes a processor to execute the region calibration method according to Example 1, or the information processing method according to Example 2 of the disclosure.

Finally, it should be noted that in this text, relational terms such as “first” and “second” are used merely to distinguish one entity or operation from another, and do not necessarily imply any actual relationship or order between these entities or operations. Moreover, the terms “comprising,” “including,” or any other variants thereof are intended to cover non-exclusive inclusions, so that a process, method, product, or apparatus that includes a series of elements not only includes those elements but also includes other elements not explicitly listed, or elements inherent to such a process, method, product, or apparatus. In the absence of further limitations, an element defined by the phrase “comprising a . . . ” does not exclude the presence of additional identical elements in the process, method, product, or apparatus that includes the said element.

The above has provided a detailed introduction to the area demarcation method, information processing method and system, apparatus, device, and medium provided by the present disclosure. Specific examples have been applied in this text to elucidate the principles and implementation methods of the present disclosure. The description of the above examples is merely for the purpose of helping to understand the method of the present disclosure and its core ideas. At the same time, for a skilled person in the art, based on the ideas of the present disclosure, there will be changes in specific implementation methods and application scopes. In summary, the content of this specification should not be understood as a limitation of the present disclosure.

After considering the specification and practicing the invention disclosed herein, a skilled person in the art will easily think of other implementation schemes of the present disclosure. The present disclosure aims to cover any variations, uses, or adaptive changes of the present disclosure, which follow the general principles of the present disclosure and include common knowledge or conventional technical means in the technical field of the present disclosure that are not disclosed. The specification and examples are only exemplary, and the true scope and spirit of the present disclosure are indicated by the following claims.

It should be understood that the present disclosure is not limited to the precise structure described above and shown in the drawings, and various modifications and changes can be made without departing from its scope. The scope of the present disclosure is limited only by the appended claims.

In this specification, the terms “an embodiment,” “embodiment.” or “one or more embodiments” mean that the specific features, structures, or characteristics described in connection with the embodiments are included in at least one embodiment of the present disclosure. In addition, please note that the phrase “in one embodiment” used here does not necessarily refer to the same embodiment.

This specification provides a large number of specific details. However, it can be understood that the embodiments of the present disclosure can be practiced without these specific details. In some cases, well-known methods, structures, and technologies are not shown in detail to avoid obscuring the understanding of this specification.

In the claims, any reference signs between brackets should not be construed as a limitation of the claims. The word “comprising” does not exclude the presence of elements or steps not listed in the claims. The word “a” or “an” before an element does not exclude the presence of more than one such element. The present disclosure can be implemented by hardware including several different elements and by a computer appropriately programmed. In unit claims listing several devices, several of these devices can be implemented by the same hardware item. The use of words such as “first.” “second,” and “third” does not imply any order. These words can be interpreted as names.

Finally, it should be noted that the above embodiments are only for the purpose of illustrating the technical solutions of the present disclosure, and are not intended to limit it. Although the present disclosure has been described in detail with reference to the above embodiments, those skilled in the art should understand that it is still possible to modify the technical solutions recorded in the above embodiments, or to replace part of the technical features with equivalent features. These modifications or replacements do not cause the essential nature of the corresponding technical solutions to deviate from the spirit and scope of the technical solutions of the various embodiments of the present disclosure.

1. A region calibration method, comprising:
displaying a scene image collected by each of at least one first image collection apparatus located in a target scene, wherein the first image collection apparatus is used for performing image collection on part or all of regions in the target scene;
displaying a candidate region selected by region drawing operation in a simulated image for simulating the target scene in response to the region drawing operation performed on the scene image;
determining a calibrated region corresponding to each of a plurality of first image collection apparatuses based on the candidate region corresponding to each of the first image collection apparatuses; and
respectively associating a plurality of calibrated regions with the plurality of first image collection apparatuses to indicate identification of objects to be identified in image regions framed by the calibrated regions in images collected by the first image collection apparatuses.

2. The region calibration method according to claim 1, wherein no overlap exists between at least two adjacent calibrated regions; and the determining a calibrated region corresponding to each of a plurality of first image collection apparatuses based on the candidate region corresponding to each of the first image collection apparatuses, comprises:
determining the calibrated region corresponding to each of the plurality of first image collection apparatuses in response to region adjustment operation on part or all of the candidate regions in a plurality of candidate regions; or
adaptively adjusting each of the candidate regions based on an overlapping region between each of the candidate regions in the simulated image to obtain the calibrated region corresponding to each of the plurality of first image collection apparatuses.

3. The region calibration method according to claim 2, wherein when the candidate region is adjusted, the method further comprises:
mapping the adjusted candidate region into the scene image from which the candidate region originates for display;
when receiving modification operation on the adjusted candidate region in the scene image, displaying a region corresponding to the modification operation in the simulated image, and repeating the step of determining a calibrated region corresponding to each of a plurality of first image collection apparatuses based on the candidate region corresponding to each of the first image collection apparatuses; and
determination of the calibrated region, comprises:
when receiving determination operation for the adjusted candidate region, taking the adjusted candidate region as the calibrated region of the corresponding first image collection apparatus.

4. The region calibration method according to claim 1, wherein the displaying a candidate region selected by region drawing operation in a simulated image for simulating the target scene, comprises:
determining an overlapping region of each of the candidate regions on the simulated image; and
displaying each of the candidate regions, and the overlapping region of each of the candidate regions.

5. The region calibration method according to claim 1, wherein after the step of displaying a candidate region selected by region drawing operation in a simulated image for simulating the target scene, the method further comprises:
displaying an uncovered region in the simulated image; wherein the uncovered region comprises a region not covered by the candidate region, or a region not covered by the calibrated region; and
determining an installation pose of a second image collection apparatus in the target scene based on the uncovered region, and taking part or all of the uncovered region as a calibrated region of the second image collection apparatus;
wherein the second image collection apparatus is used for being newly added to the target scene to collect an image of the uncovered region.

6. The region calibration method according to claim 5, wherein the determining an installation pose of a second image collection apparatus in the target scene based on the uncovered region, comprises:
acquiring a target image obtained by the second image collection apparatus performing image collection on the target scene at a candidate position;
mapping a scene region comprised in the target image into the simulated image to obtain a collection region;
outputting position adjustment information based on the collection region and the uncovered region; and
determining the installation pose based on the position adjustment information.

7. The region calibration method according to claim 6, wherein the outputting position adjustment information based on the collection region and the uncovered region, comprises:
determining a type of coverage of the collection region covering the uncovered region;
generating the position adjustment information based on the type of coverage; wherein the position adjustment information comprises a movement direction or a movement distance of the candidate position; and
sending the position adjustment information to a user side.

8. The region calibration method according to claim 6, wherein the outputting position adjustment information based on the collection region and the uncovered region, comprises:
performing picture interception on the simulated image displaying the collection region and the uncovered region; and
sending an intercepted picture to the user side as the position adjustment information so as to display the intercepted picture at the user side.

9. The region calibration method according to claim 1, wherein the displaying a candidate region selected by region drawing operation in a simulated image for simulating the target scene in response to the region drawing operation performed on the scene image collected by the first image collection apparatus, comprises:
determining a first region coordinate of a drawing region selected by the region drawing operation on the scene image in response to the region drawing operation;
converting the first region coordinate into a second region coordinate on the simulated image; and
mapping the drawing region onto the simulated image based on the second region coordinate to obtain the candidate region.

10. The region calibration method according to claim 1, wherein the displaying a candidate region selected by region drawing operation in a simulated image for simulating the target scene in response to the region drawing operation performed on the scene image collected by the first image collection apparatus, comprises:
generating a closed image region on the scene image in response to a plurality of position points where preset operation is executed on the scene image, and/or a plurality of lines drawn on the scene image; and
mapping the closed image region into the simulated image for display to obtain the candidate region.

11. The region calibration method according to claim 1, wherein before the displaying a candidate region selected by region drawing operation in a simulated image for simulating the target scene, the method further comprises:
acquiring a marked image collected by an image collection apparatus, wherein the marked image comprises images of a plurality of marking icons located in the target scene; and the image collection apparatus comprises the first image collection apparatus and the second image collection apparatus;
respectively determining image coordinates of the plurality of marking icons in the marked image, and determining world coordinates where the plurality of marking icons are located;
determining a first coordinate conversion parameter corresponding to each of the image collection apparatuses based on the image coordinates and the world coordinates; and
determining a second coordinate conversion parameter based on a world coordinate system and a coordinate system of the simulated image; wherein the first coordinate conversion parameter and the second coordinate conversion parameter are used for mapping an image region selected by the region drawing operation on the scene image into a candidate region in the simulated image.

12. The region calibration method according to claim 11, further comprising:
determining a calibrated coordinate of a calibrated region associated with the image collection apparatus in the world coordinate system based on the first coordinate conversion parameter;
when detecting a third image collection apparatus having a changed pose, updating a first coordinate conversion parameter corresponding to the third image collection apparatus;
determining a calibrated region corresponding to the third image collection apparatus after the pose changes based on the updated first coordinate conversion parameter and a calibrated coordinate corresponding to the third image collection apparatus; and
associating the calibrated region corresponding to the third image collection apparatus after a position changes with the third image collection apparatus.

13. An information processing method, comprising:
respectively acquiring scene images collected by a plurality of image collection apparatuses on a target scene, and determining calibrated regions respectively corresponding to the plurality of image collection apparatuses; wherein the calibrated regions are determined by the region calibration method according to claim 1;
identifying objects to be identified in target regions of the scene images to obtain target information; wherein the target regions are regions framed by the calibrated regions; and
executing information processing corresponding to a scene task on each piece of the target information, wherein the scene task is a task corresponding to the target scene.

14. The information processing method according to claim 13, wherein the executing information processing corresponding to a scene task on each piece of the target information, comprises:
executing information processing corresponding to a target image display function on each piece of the target information in response to the target image display function triggered on a third drawing interface; wherein a plurality of image display functions are preset on the third drawing interface, and different image display functions correspond to different scene tasks; and
displaying a processing result of the information processing on a simulated image for simulating the target scene.

15. The information processing method according to claim 13, wherein the target information comprises position information of the objects to be identified, the scene task comprises: a position display task and/or an object statistics task, and executing information processing corresponding to the scene task on each piece of the position information, comprises:
in the case where the scene task is the position display task, mapping each piece of the position information into the simulated image for simulating the target scene for display; and
in the case where the scene task is the object statistics task, performing statistics on a plurality of pieces of position information to obtain statistical information, and rendering the statistical information in the simulated image;
performing statistics on positions of the objects to be identified which are identified in a plurality of scene images to obtain statistical information, comprises at least one of:
performing statistics on position information of the same object to be identified which is identified in the plurality of scene images to obtain trajectory information of the same object to be identified; and
performing statistics on a calibrated region to which the position information belongs to obtain quantity information of the objects to be identified in different calibrated regions.

16. (canceled)

17. The information processing method according to claim 13, wherein the objects to be identified are human bodies, and the identifying objects to be identified in target regions of the scene images, comprises:
detecting feet of the human body in the target region;
under the condition that the feet are detected, identifying positions of the feet; and
under the condition that the feet are not detected, predicting the positions of the feet based on a position of at least one target part of the human body; wherein the target part is a part in the human body other than the feet;
wherein the predicting the positions of the feet based on a position of at least one target part of the human body, comprises:
detecting a head position of the human body and a body position of the human body in the target region;
determining a posture category of the human body based on the head position and/or the body position; and
predicting the positions of the feet based on the posture category;
wherein detecting a head position of the human body and a body position of the human body in the target region, comprises:
detecting a head position box where a head is located and a body position box where a body is located;
the determining a posture category of the human body based on the head position and/or the body position, comprises:
in the case where the head position box and the body position box are detected, determining the posture category based on a size ratio between the head position box and the body position box; and
in the case where the head position box or the body position box is detected, determining the posture category as a preset category corresponding to the detected position box.

18-19. (canceled)

20. The information processing method according to claim 13, wherein determining calibrated regions respectively corresponding to the plurality of image collection apparatuses, comprises:
determining a calibrated region corresponding to a current image collection apparatus from a preset calibrated region library; wherein a region coordinate of the calibrated region corresponding to each of a plurality of image collection apparatuses is stored in the preset calibrated region library; or
determining the calibrated region based on the region coordinate carried in the scene image collected by the image collection apparatus.

21-24. (canceled)

25. An electronic device, comprising: a memory, a processor, and a computer program stored on the memory and capable of running on the processor, wherein the processor implements the region calibration method according to claim 1 during execution.

26. A computer-readable storage medium, wherein a computer program stored therein causes a processor to execute the region calibration method according to claim 1.

27. An electronic device, comprising: a memory, a processor, and a computer program stored on the memory and capable of running on the processor, wherein the processor implements the information processing method according to claim 13 during execution.
